(19) United States
(12) Patent Application Publication
(10) Pub. No.: US 2010/0067076 A1
(43) Pub. Date: Mar. 18, 2010

(54) HOLOGRAPHIC PRINTER

(76) Inventor: David Brotherton-Ratcliffe, West Sussex (GB)

Correspondence Address: PAUL S MADAN;MADAN & SRIRAM, PC, 2603 AUGUSTA DRIVE, SUITE 700, HOUSTON, TX, 77057-5662, US

(21) Appl. No.: 12/298,658

(22) PCT Filed: Apr. 27, 2007
(86) PCT No.: PCT/GB07/01569

§ 371 Date: May 29, 2009

(30) Foreign Application Priority Data
Apr. 27, 2006 (GB) 0608321.6

(51) Int. Cl. G03H 1/20

(52) U.S. Cl. 359/12

(57) ABSTRACT

A holographic printer, a hologram copier and a combined holographic printer and hologram copier system is disclosed. The printer, copier and combined system comprise a pulsed RGB laser system comprising three short cavity oscillators. With the holographic printer digital image data is encoded onto three LCOS reflective SLM displays. The combined holographic printer and hologram copier system comprises a single RGB laser system.

The present invention relates to a holographic printer, a laser source for a holographic printer, a method of printing holograms, a pulsed laser source for a holographic printer, a method of generating a pulsed laser beam for use by a holographic printer, a hologram copier, a method of copying a hologram, a combined holographic printer and hologram copier and a method of printing a hologram and copying a hologram.

1-step and 2-step digital holographic printers comprising pulsed RGB lasers and transmissive LCD panels are in current commercial use. These current commercial holographic printers represent a significant improvement over older known digital holographic printers which use CW lasers. However, current commercial holographic printers which utilise pulsed RGB lasers are still relatively slow, relatively large and are relatively sensitive to external environmental conditions. In particular, the transmissive LCDs which are used in such commercial printers require the pulsed lasers to have a relatively high energy. As a result, the laser sources have a relatively long cavity length and this can degrade the stability of the holographic printer.

Copying digital holograms is also currently relatively problematic since high speed copying and production of holograms is required for commercial reasons. Furthermore, conventional holographic printers generally produce master holograms having shifted replay wavelengths which cannot be copied effectively.

Another problem with conventional holographic printers is that conventional commercial diode illumination sources are not matched to the laser wavelengths used by the holographic printers. Therefore, inferior halogen lighting sources are often used to illuminate the holograms produced by these holographic printers.

It is therefore desired to provide an improved holographic printer and an improved copier for copying holograms.

According to an aspect of the present invention there is provided a holographic printer for printing holograms comprising:

a pulsed laser source arranged to produce a first laser beam at a first wavelength which is split, in use, into a first object beam and a first reference beam which is mutually coherent with the first object beam;

a first spatial light modulator for encoding data onto the first object beam;

a first lens system for writing a holographic pixel of a hologram onto a photosensitive medium which is arranged, in use, downstream of the first lens system; and

positioning means for positioning a photosensitive medium downstream of the first lens system;

wherein the first spatial light modulator comprises a first reflective spatial light modulator.

The first object beam is preferably reflected, in use, by the first reflective spatial light modulator. The first reflective spatial light modulator preferably comprises a Liquid Crystal On Silicon (“LCOS”) display.

The holographic printer preferably further comprises a first polarizing beam splitter. The first object beam is preferably transmitted or reflected, in use, by the first polarizing beam splitter and the beam is then preferably reflected by the first reflective spatial light modulator and is then preferably transmitted or reflected by the first polarizing beam splitter.

The first lens system preferably comprises a first telecentric afocal reversing system arranged downstream of the first reflective spatial light modulator. The first lens system preferably comprises a first focusing lens arranged downstream of the first telecentric afocal reversing system. The first focusing lens preferably has a numerical aperture selected from the group consisting of: (i) >60°; (ii) 60-70°; (iii) 70-80°; (iv) 80-90°; (v) 90-100°; (vi) 100-110°; (vii) 110-120°; and (viii) >120°.

The positioning means is preferably arranged to position the photosensitive medium x₁ mm downstream from the Fourier plane of the first lens system. Preferably, x₁ is selected from the group consisting of: (i) 0 mm; (ii) <1 mm; (iii) 1-2 mm; (iv) 2-3 mm; (v) 3-4 mm; (vi) 4-5 mm; (vii) 5-6 mm; (viii) 6-7 mm; (ix) 7-8 mm; (x) 8-9 mm; (xi) 9-10 mm; and (xii) >10 mm.

The Fourier plane of the first lens system is preferably located y₁ mm downstream from the end of the first lens system. Preferably, y₁ is selected from the group consisting of: (i) <2 mm; (ii) 2-3 mm; (iii) 3-4 mm; (iv) 4-5 mm; (v) 5-6 mm; (vi) 6-7 mm; (vii) 7-8 mm; (viii) 8-9 mm; (ix) 9-10 mm; and (x) >10 mm.

The holographic printer preferably further comprises a first microlens array arranged upstream of the first reflective spatial light modulator wherein the first object beam is preferably transmitted, in use, through the first microlens array.

The first object beam and/or the first reference beam preferably has a wavelength falling within a range selected from the group consisting of: (i) <400 nm; (ii) 400-410 nm; (iii) 410-420 nm; (iv) 420-430 nm; (v) 430-440 nm; (vi) 440-450 nm; (vii) 450-460 nm; (viii) 460-470 nm; (ix) 470-480 nm; (x) 480-490 nm; (xi) 490-500 nm; (xii) 500-510 nm; (xiii) 510-520 nm; (xiv) 520-530 nm; (xv) 530-540 nm; (xvi) 540-550 nm; (xvii) 550-560 nm; (xviii) 560-570 nm; (xix) 570-580 nm; (xx) 580-590 nm; (xxi) 590-600 nm; (xxii) 600-610 nm; (xxiii) 610-620 nm; (xxiv) 620-630 nm; (xxv) 630-640 nm; (xxvi) 640-650 nm; (xxvii) 650-660 nm; (xxviii) 660-670 nm; (xxix) 670-680 nm; (xxx) 680-690 nm; (xxxi) 690-700 nm; and (xxxii) >700 nm.

The pulsed laser source is preferably further arranged to produce a second laser beam at a second wavelength which is split, in use, into a second object beam and a second reference beam which is mutually coherent with the second object beam.

The holographic printer preferably further comprises a second spatial light modulator for encoding data onto the second object beam. The second spatial light modulator preferably comprises a second reflective spatial light modulator. The second object beam is preferably reflected, in use, by the second reflective spatial light modulator. The second reflective spatial light modulator preferably comprises a Liquid Crystal On Silicon (“LCOS”) display.

The holographic printer preferably further comprises a second polarizing beam splitter. The second object beam is preferably transmitted or reflected, in use, by the second polarizing beam splitter and is then preferably reflected by the second reflective spatial light modulator and is then preferably transmitted or reflected by the second polarizing beam splitter.

The holographic printer preferably further comprises a second lens system for writing a holographic pixel of a hologram onto a photosensitive medium which is arranged, in use, downstream of the second lens system. The second lens system preferably comprises a second telecentric afocal reversing system arranged downstream of the second reflective spatial light modulator. The second lens system preferably comprises a second focusing lens arranged downstream of the second telecentric afocal reversing system. The second focusing lens preferably has numerical aperture selected from the group consisting of: (i) >60°; (ii) 60-70°; (iii) 70-80°; (iv) 80-90°; (v) 90-100°; (vi) 100-110°; (vii) 110-120°; and (viii) >120°.

The positioning means is preferably arranged to position the photosensitive medium x₂ mm downstream from the Fourier plane of the second lens system. Preferably, x₂ is selected from the group consisting of: (i) 0 mm; (ii) <1 mm; (iii) 1-2 mm; (iv) 2-3 mm; (v) 3-4 mm; (vi) 4-5 mm; (vii) 5-6 mm; (viii) 6-7 mm; (ix) 7-8 mm; (x) 8-9 mm; (xi) 9-10 mm; and (xii) >10 mm.

The Fourier plane of the second lens system is preferably located y₂ mm downstream from the end of the second lens system. Preferably, y₂ is selected from the group consisting of: (i) <2 mm; (ii) 2-3 mm; (iii) 3-4 mm; (iv) 4-5 mm; (v) 5-6 mm; (vi) 6-7 mm; (vii) 7-8 mm; (viii) 8-9 mm; (ix) 9-10 mm; and (x) >10 mm.

The holographic printer preferably further comprises a second microlens array arranged upstream of the second reflective spatial light modulator wherein the second object beam is transmitted, in use, through the second microlens array.

The second object beam and/or the second reference beam preferably has a wavelength falling within a range selected from the group consisting of: (i) <400 nm; (ii) 400-410 nm; (iii) 410-420 nm; (iv) 420-430 nm; (v) 430-440 nm; (vi) 440-450 nm; (vii) 450-460 nm; (viii) 460-470 nm; (ix) 470-480 nm; (x) 480-490 nm; (xi) 490-500 nm; (xii) 500-510 nm; (xiii) 510-520 nm; (xiv) 520-530 nm; (xv) 530-540 nm; (xvi) 540-550 nm; (xvii) 550-560 nm; (xviii) 560-570 nm; (xix) 570-580 nm; (xx) 580-590 nm; (ud) 590-600 nm; (xxii) 600-610 nm; (xxiii) 610-620 nm; (xxiv) 620-630 nm; (xxv) 630-640 nm; (xxvi) 640-650 nm; (xxvii) 650-660 nm; (xxviii) 660-670 nm; (xxix) 670-680 nm; (xxx) 680-690 nm; (xxxi) 690-700 nm; and (xxiii) >700 nm.

The pulsed laser source is preferably arranged to produce a third laser beam at a third wavelength which is split, in use, into a third object beam and a third reference beam which is mutually coherent with the third object beam.

The holographic printer preferably further comprises a third spatial light modulator for encoding data onto the third object beam. The third spatial light modulator preferably comprises a reflective spatial light modulator.

The third object beam is preferably reflected, in use, by the third reflective spatial light modulator. The third reflective spatial light modulator preferably comprises a Liquid Crystal On Silicon (“LCOS”) display.

The holographic printer preferably further comprises a third polarizing beam splitter. The third object beam is preferably transmitted or reflected, in use, by the third polarizing beam splitter and is then preferably reflected by the third reflective spatial light modulator and is then preferably transmitted or reflected by the third polarizing beam splitter.

The holographic printer preferably, further comprises a third lens system for writing a holographic pixel of a hologram onto a photosensitive medium which is arranged, in use, downstream of the third lens system. The third lens system preferably comprises a third telecentric afocal reversing system arranged downstream of the third reflective spatial light modulator. The third lens system preferably comprises a third focusing lens arranged downstream of the third telecentric afocal reversing system. The third focusing lens preferably has numerical aperture selected from the group consisting of: (i) >60°; (ii) 60-70°; (iii) 70-80°; (iv) 80-90°; (v) 90-100°; (vi) 100-110°; (vii) 110-120°; and (viii) >120°.

The positioning means is preferably arranged to position the photosensitive medium x₃ mm downstream from the Fourier plane of the third lens system. Preferably, x₃ is selected from the group consisting of: (i) 0 mm; (ii) <1 mm; (iii) 1-2 mm; (iv) 2-3 mm; (v) 3-4 mm; (vi) 4-5 mm; (vii) 5-6 mm; (viii) 6-7 mm; (ix) 7-8 mm; (x) 8-9 mm; (xi) 9-10 mm; and (xii) >10 mm.

The Fourier plane of the third lens system is preferably located y₃ mm downstream of the third lens system. Preferably, y₃ is selected from the group consisting of: (i) <2 mm; (ii) 2-3 mm; (iii) 3-4 mm; (iv) 4-5 mm; (v) 5-6 mm; (vi) 6-7 mm; (vii) 7-8 mm; (viii) 8-9 mm; (ix) 9-10 mm; and (x) >10 mm.

The holographic printer preferably further comprises a third microlens array arranged upstream of the third reflective spatial light modulator wherein the third object beam is transmitted, in use, through the third microlens array.

The third object beam and/or the third reference beam preferably has a wavelength falling within a range selected from the group consisting of: (i) <400 nm; (ii) 400-410 nm; (iii) 410-420 nm; (iv) 420-430 nm; (v) 430-440 nm; (vi) 440-450 nm; (vii) 450-460 nm; (viii) 460-470 nm; (ix) 470-480 nm; (x) 480-490 nm; (xi) 490-500 nm; (xii) 500-510 nm; (xiii) 510-520 nm; (xiv) 520-530 nm; (xv) 530-540 nm; (xvi) 540-550 nm; (xvii) 550-560 nm; (xviii) 560-570 nm; (xix) 570-580 nm; (xx) 580-590 nm; (xxi) 590-600 nm; (xxii) 600-610 nm; (xxiii) 610-620 nm; (xxiv) 620-630 nm; (xxv) 630-640 nm; (xxvi) 640-650 nm; (xxvii) 650-660 nm; (xxviii) 660-670 nm; (xxix) 670-680 nm; (xxx) 680-690 nm; (xxxi) 690-700 nm; and (xxxii) >700 nm.

The pulsed laser source preferably comprises a first oscillator comprising a first active medium, wherein the first oscillator has a cavity length <200 mm. The first oscillator preferably comprises a crystal of Nd:YAG which is arranged to emit laser radiation at 1319 nm. The holographic printer preferably further comprises means for frequency doubling the laser radiation at 1319 nm to produce laser radiation at 660 nm.

The pulsed laser source preferably comprises a second oscillator comprising a second active medium, wherein the second oscillator has a cavity length <200 mm. The second oscillator preferably comprises a crystal of Nd:YAG which is arranged to emit laser radiation at 1064 nm. The holographic printer preferably further comprises means for frequency doubling the laser radiation at 1064 nm to produce laser radiation at 532 nm.

The pulsed laser source preferably comprises a third oscillator comprising a third active medium, wherein the third oscillator has a cavity length <200 mm. The third oscillator preferably comprises a crystal of Nd:YAG which is arranged to emit laser radiation at 1319 nm. The holographic printer preferably further comprises means for frequency trebling the laser radiation at 1319 nm to produce laser radiation at 440 nm.

According to an embodiment of the present invention the first oscillator and/or the second oscillator and/or the third oscillator have a cavity length selected from the group consisting of: (i) <50 mm; (ii) 50-60 mm; (iii) 60-70 mm; (iv) 70-80 mm; (v) 80-90 mm; (vi) 90-100 mm; (vii) 100-110 mm; (viii) 110-120 mm; (ix) 120-130 mm; (x) 130-140 mm; (xi) 140-150 mm; (xii) 150-160 mm; (xiii) 160-170 mm; (xiv) 170-180 mm; (xv) 180-190 mm; and (xvi) 190-200 mm.

The first active medium and/or the second active medium and/or the third active medium are preferably selected from the group consisting of: (i) Nd:YAG; (ii) Nd:YLF; (iii) Nd:YAP; (iv) Nd:BEL; (v) Nd:YVO₄; and (vi) Nd:GdVO₄.

The first active medium and/or the second active medium and/or the third active medium preferably comprise a rod having a length selected from the group consisting of: (i) <10 mm; (ii) 10-20 mm; (iii) 20-30 mm; (iv) 30-40 mm; (v) 40-50 mm; (vi) 50-60 mm; (vii) 60-70 mm; (viii) 70-80 mm; (ix) 80-90 mm; (x) 90-100 mm; and (xi) >100 mm.

The holographic printer preferably further comprises means for pumping the first active medium and/or the second active medium and/or the third active medium. The means for pumping the first active medium and/or the second active medium and/or the third active medium preferably comprises one or more lamps.

According to an embodiment the holographic printer preferably further comprises means for increasing a voltage applied to the one or more lamps as a function of time and/or usage.

According to another embodiment the means for pumping the first active medium and/or the second active medium and/or the third active medium preferably comprises one or more diodes.

The pulsed laser source preferably comprises one or more Q-switches. The one or more Q-switches are preferably selected from the group consisting of: (i) Cr:YAG; (ii) Co:MALO; (iii) Gadolinium Scandium Gallium garnet (“GSGG”); and (iv) V:YAG.

The holographic printer preferably comprises a 1-step or Direct Write holographic printer and/or a 2-step or Master Write holographic printer.

According to another aspect of the present invention there is provided a method of printing holograms comprising:

providing a pulsed laser source which produces a first laser beam at a first wavelength;

splitting the first laser beam into a first object beam and a first reference beam which is mutually coherent with the first object beam;

encoding data onto the first object beam using a first spatial light modulator;

writing a holographic pixel of a hologram onto a photosensitive medium using a first lens system; and

positioning a photosensitive medium downstream of the first lens system;

wherein the first spatial light modulator comprises a first reflective spatial light modulator.

According to another aspect of the present invention there is provided a holographic printer comprising a pulsed laser source. The pulsed laser source preferably comprises a first oscillator comprising a first active medium, wherein the first oscillator preferably has a cavity length <200 mm.

The first oscillator preferably comprises a crystal comprising Nd:YAG which is arranged to emit laser radiation at 1319 nm. The holographic printer preferably further comprises means for frequency doubling the laser radiation at 1319 nm to produce laser radiation at 660 nm.

According to an embodiment the first oscillator provides a first pulsed laser beam having a pulse duration selected from the group consisting of: (i) <1 ns; (ii) 1-10 ns; (iii) 10-20 ns; (iv) 20-30 ns; (v) 30-40 ns; (vi) 40-50 ns; (vii) 50-60 ns; (viii) 60-70 ns; (ix) 70-80 ns; (x) 80-90 ns; (xi) 90-100 ns; (xii) 100-200 ns; (xiii) 200-300 ns; (xiv) 300-400 ns; (xv) 400-500 ns; and (xvi) >500 ns.

The first oscillator preferably has a pulse repetition rate selected from the group consisting of: (i) <1 Hz; (ii) 1-10 Hz; (iii) 10-20 Hz; (iv) 20-30 Hz; (v) 30-40 Hz; (vi) 40-50 Hz; (vii) 50-60 Hz; (viii) 60-70 Hz; (ix) 70-80 Hz; (x) 80-90 Hz; (xi) 90-100 Hz; (xii) 100-150 Hz; (xiii) 150-200 Hz; (xiv) 200-250 Hz; (xv) 250-300 Hz; (xvi) 300-350 Hz; (xvii) 350-400 Hz; (xviii) 400-450 Hz; (xix) 450-500 Hz; (xx) 500-1000 Hz; (xxi) 1-2 kHz; (xxii) 2-3 kHz; (xxiii) 3-4 kHz; (xxiv) 4-5 kHz; (xxv) 5-6 kHz; (xxvi) 6-7 kHz; (xxvii) 7-8 kHz; (xxviii) 8-9 kHz; (xxix) 9-10 kHz; and (xxx) >10 kHz.

According to the preferred embodiment the first oscillator provides a first pulsed laser beam having a single longitudinal mode or TEM₀₀.

The pulsed laser source preferably further comprises a second oscillator comprising a second active medium, wherein the second oscillator preferably has a cavity length <200 mm.

The second oscillator preferably comprises a crystal of Nd:YAG which is arranged to emit laser radiation at 1064 nm. The holographic printer preferably further comprises means for frequency doubling the laser radiation at 1064 nm to produce laser radiation at 532 nm.

The second oscillator preferably provides a second pulsed laser beam having a pulse duration selected from the group consisting of: (i) <1 ns; (ii) 1-10 ns; (iii) 10-20 ns; (iv) 20-ns; (v) 30-40 ns; (vi) 40-50 ns; (vii) 50-60 ns; (viii) 60-70 ns; (ix) 70-80 ns; (x) 80-90 ns; (xi) 90-100 ns; (xii) 100-200 ns; (xiii) 200-300 ns; (xiv) 300-400 ns; (xv) 400-500 ns; and (xvi) >500 ns.

The second oscillator preferably has a pulse repetition rate selected from the group consisting of: (i) <1 Hz; (ii) 1-10 Hz; (iii) 10-20 Hz; (iv) 20-30 Hz; (v) 30-40 Hz; (vi) 40-50 Hz; (vii) 50-60 Hz; (viii) 60-70 Hz; (ix) 70-80 Hz; (x) 80-90 Hz; (xi) 90-100 Hz; (xii) 100-150 Hz; (xiii) 150-200 Hz; (xiv) 200-250 Hz; (xv) 250-300 Hz; (xvi) 300-350 Hz; (xvii) 350-400 Hz; (xviii) 400-450 Hz; (xix) 450-500 Hz; (xx) 500-1000 Hz; (xxi) 1-2 kHz; (xxii) 2-3 kHz; (xxiii) 3-4 kHz; (xxiv) 4-5 kHz; (xxv) 5-6 kHz; (xxvi) 6-7 kHz; (xxvii) 7-8 kHz) (xxviii) 8-9 kHz; (xxix) 9-10 kHz; and (xxx) >10 kHz.

The second oscillator preferably provides a second pulsed laser beam having a single longitudinal mode or TEM₀₀.

The pulsed laser source preferably further comprises a third oscillator comprising a third active medium, wherein the third oscillator preferably has a cavity length <200 mm.

The third oscillator preferably comprises a crystal of Nd:YAG which is arranged to emit laser radiation at 1319 nm. The holographic printer preferably further comprises means for frequency trebling the laser radiation at 1319 nm to produce laser radiation at 440 nm.

The third oscillator preferably provides a third pulsed laser beam having a pulse duration selected from the group consisting of: (i) <1 ns; (ii) 1-10 ns; (iii) 10-20 ns; (iv) 20-30 ns; (v) 30-40 ns; (vi) 40-50 ns; (vii) 50-60 ns; (viii) 60-70 ns; (ix) 70-80 ns; (x) 80-90 ns; (xi) 90-100 ns; (xii) 100-200 ns; (xiii) 200-300 ns; (xiv) 300-400 ns; (xv) 400-500 ns; and (xvi) >500 ns.

The third oscillator preferably has a pulse repetition rate selected from the group consisting of: (i) <1 Hz; (ii) 1-10 Hz; (iii) 10-20 Hz; (iv) 20-30 Hz; (v) 30-40 Hz; (vi) 40-50 Hz; (vii) 50-60 Hz; (viii) 60-70 Hz; (ix) 70-80 Hz; (x) 80-90 Hz; (xi) 90-100 Hz; (xii) 100-150 Hz; (xiii) 150-200 Hz; (xiv) 200-250 Hz; (xv) 250-300 Hz; (xvi) 300-350 Hz; (xvii) 350-400 Hz; (xviii) 400-450 Hz; (xix) 450-500 Hz; (xx) 500-1000 Hz; (xxi) 1-2 kHz; (xxii) 2-3 kHz; (xxiii) 3-4 kHz; (xxiv) 4-5 kHz; (xxv) 5-6 kHz; (xxvi) 6-7 kHz; (xxvii) 7-8 kHz; (xxviii) 8-9 kHz; (xxix) 9-10 kHz; and (xxx) >10 kHz.

According to a preferred embodiment the third oscillator preferably provides a third pulsed laser beam having a single longitudinal mode or TEM₀₀.

The first oscillator and/or the second oscillator and/or the third oscillator preferably have a cavity length selected from the group consisting of: (i) <50 mm; (ii) 50-60 mm; (iii) 60-70 mm; (iv) 70-80 mm; (v) 80-90 mm; (vi) 90-100 mm; (vii) 100-110 mm; (viii) 110-120 mm; (ix) 120-130 mm; (x) 130-140 mm; (xi) 140-150 mm; (xii) 150-160 mm; (xiii) 160-170 mm; (xiv) 170-180 mm; (xv) 180-190 mm; and (xvi) 190-200 mm.

The first active medium and/or the second active medium and/or the third active medium are preferably selected from the group consisting of: (i) Nd:YAG; (ii) Nd:YLF; (iii) Nd:YAP; (iv) Nd:BEL; (v) Nd:YVO₄; and (vi) Nd:GdVO₄.

The first active medium and/or the second active medium and/or the third active medium preferably comprise a rod having a length selected from the group consisting of: (i) <10 mm; (ii) 10-20 mm; (iii) 20-30 mm; (iv) 30-40 mm; (v) 40-50 mm; (vi) 50-60 mm; (vii) 60-70 mm; (viii) 70-80 mm; (ix) 80-90 mm; (x) 90-100 mm; and (xi) >100 mm.

The holographic printer preferably further comprises means for pumping the first active medium and/or the second active medium and/or the third active medium.

According to an embodiment the means for pumping the first active medium and/or the second active medium and/or the third active medium comprises one or more lamps.

According to an embodiment the holographic printer preferably further comprises means for increasing a voltage applied to the one or more lamps as a function of time and/or usage.

According to another embodiment the means for pumping the first active medium and/or the second active medium and/or the third active medium comprises one or more diodes.

The pulsed laser source preferably further comprises one or more Q-switches. The one or more Q-switches are preferably selected from the group consisting of: (i) Cr:YAG; (ii) Co:MALO; (iii) Gadolinium Scandium Gallium garnet (“GSGG”); and (iv) V:YAG.

The holographic printer preferably further comprises one or more optical amplifiers for amplifying the output of the pulsed laser source.

The holographic printer preferably further comprises means for actively and/or passively stabilising the temperature of the first oscillator and/or the second oscillator and/or the third oscillator.

According to an embodiment the first oscillator comprises a first output coupler and/or the second oscillator comprises a second output coupler and/or the third oscillator comprises a third output coupler and wherein the holographic printer further comprises:

means for actively and/or passively stabilising the temperature of the first output coupler; and/or

means for actively and/or passively stabilising the temperature of the second output coupler; and/or

means for actively and/or passively stabilising the temperature of the third output coupler.

The holographic printer preferably further comprises means for actively and/or passively controlling the cavity length of the first oscillator and/or the second oscillator and/or the third oscillator.

According to an embodiment the first oscillator further comprises a first rear mirror and/or the second oscillator comprises a second rear mirror and/or the third oscillator comprises a third rear mirror and wherein:

the means for actively controlling the cavity length of the first oscillator and/or the second oscillator and/or the third oscillator is arranged to thermally and/or piezo-electrically vary the first rear mirror and/or the second rear mirror and/or the third rear mirror.

According to an embodiment the first oscillator comprises a first output coupler and/or the second oscillator comprises a second output coupler and/or the third oscillator comprises a third output coupler and wherein:

the means for actively and/or passively controlling the cavity length of the first oscillator and/or the second oscillator and/or the third oscillator is arranged to thermally and/or piezo-electrically vary the first output coupler and/or the second output coupler and/or the third output coupler.

The holographic printer preferably further comprises means for injection seeding the first oscillator and/or the second oscillator and/or the third oscillator.

The first oscillator and/or the second oscillator and/or the third oscillator preferably comprise a linear cavity. According to a less preferred embodiment the first oscillator and/or the second oscillator and/or the third oscillator may comprise a ring cavity.

According to another aspect of the present invention there is provided a method of printing a hologram comprising:

providing a holographic printer comprising a pulsed laser source comprising a first oscillator comprising a first active medium, wherein the first oscillator has a cavity length <200 mm; and

using the holographic printer to print a hologram.

According to another aspect of the present invention there is provided a hologram copier comprising a pulsed laser source. The pulsed laser source preferably comprises a first oscillator comprising a first active medium, wherein the first oscillator has a cavity length <200 mm.

The first oscillator preferably comprises a crystal of Nd:YAG which is arranged to emit laser radiation at 1319 nm. The hologram copier preferably further comprises means for frequency doubling the laser radiation at 1319 nm to produce laser radiation at 660 nm.

The pulsed laser source preferably further comprises a second oscillator comprising a second active medium, wherein the second oscillator has a cavity length <200 mm. The second oscillator preferably comprises a crystal of Nd:YAG which is preferably arranged to emit laser radiation at 1064 nm. The hologram copier preferably further comprises means for frequency doubling the laser radiation at 1064 nm to produce laser radiation at 532 nm.

The pulsed laser source preferably further comprises a third oscillator comprising a third active medium, wherein the third oscillator preferably has a cavity length <200 mm.

The third oscillator preferably comprises a crystal of Nd:YAG which is arranged to emit laser radiation at 1319 nm. The hologram copier preferably further comprises means for frequency trebling the laser radiation at 1319 nm to produce laser radiation at 440 nm.

The first oscillator and/or the second oscillator and/or the third oscillator preferably have a cavity length selected from the group consisting of: (i) <50 mm; (ii) 50-60 mm; (iii) 60-70 mm; (iv) 70-80 mm; (v) 80-90 mm; (vi) 90-100 mm; (vii) 100-110 mm; (viii) 110-120 mm; (ix) 120-130 mm; (x) 130-140 mm; (xi) 140-150 mm; (xii) 150-160 mm; (xiii) 160-170 mm; (xiv) 170-180 mm; (xv) 180-190 mm; and (xvi) 190-200 mm.

The first active medium and/or the second active medium and/or the third active medium are preferably selected from the group consisting of: (i) Nd:YAG; (ii) Nd:YLF; (iii) Nd:YAP; (iv) Nd:BEL; (v) Nd:YVO₄; and (vi) Nd:GdVO₄.

The first active medium and/or the second active medium and/or the third active medium preferably comprise a rod having a length selected from the group consisting of: (i) <10 mm; (ii) 10-20 mm; (iii) 20-30 mm; (iv) 30-40 mm; (v) 40-50 mm; (vi) 50-60 mm; (vii) 60-70 mm; (viii) 70-80 mm; (ix) 80-90 mm; (x) 90-100 mm; and (xi) >100 mm.

The hologram copier preferably further comprises means for pumping the first active medium and/or the second active medium and/or the third active medium. The means for pumping the first, active medium and/or the second active medium and/or the third active medium preferably comprises one or more lamps.

According to an embodiment the hologram copier further comprises means for increasing a voltage applied to the one or more lamps as a function of time and/or usage.

According to an alternative embodiment the means for pumping the first active medium and/or the second active medium and/or the third active medium comprises one or more diodes.

The pulsed laser source preferably further comprises one or more Q-switches. The one or more Q-switches are preferably selected from the group consisting of: (i) Cr:YAG; (ii) Co:MALO; (iii) Gadolinium Scandium Gallium garnet (“GSGG”); and (iv) V:YAG.

The hologram copier preferably further comprises means for actively and/or passively stabilising the temperature of the first oscillator and/or the second oscillator and/or the third oscillator.

According to an embodiment the first oscillator comprises a first output coupler and/or the second oscillator comprises a second output coupler and/or the third oscillator comprises a third output coupler and wherein the hologram copier further comprises:

means for actively and/or passively stabilising the temperature of the first output coupler; and/or

means for actively and/or passively stabilising the temperature of the second output coupler; and/or

means for actively and/or passively stabilising the temperature of the third output coupler.

The hologram copier preferably further comprises means for actively and/or passively controlling the cavity length of the first oscillator and/or the second oscillator and/or the third oscillator.

According to an embodiment the first oscillator comprises a first rear mirror and/or the second oscillator comprises a second rear mirror and/or the third oscillator comprises a third rear mirror and wherein the means for actively and/or passively controlling the cavity length of the first oscillator and/or the second oscillator and/or the third oscillator is arranged to thermally and/or piezo-electrically vary the first rear mirror and/or the second rear mirror and/or the third rear mirror.

According to an embodiment the first oscillator comprises a first output coupler and/or the second oscillator comprises a second output coupler and/or the third oscillator comprises a third output coupler and wherein the means for actively and/or passively controlling the cavity length of the first oscillator and/or the second oscillator and/or the third oscillator is arranged to thermally or piezo-electrically vary the first output coupler and/or the second output coupler and/or the third output coupler.

The hologram copier preferably further comprise means for injection seeding the first oscillator and/or the second oscillator and/or the third oscillator.

The first oscillator and/or the second oscillator and/or the third oscillator preferably comprise a linear cavity. According to an alternative less preferred embodiment the first oscillator and/or the second oscillator and/or the third oscillator may comprise a ring cavity.

The hologram copier preferably comprises a contact copier.

The hologram copier preferably uses either a 1D line scanning pattern and/or a 2D spot scanning pattern.

The hologram copier is preferably arranged to copy one or more master holograms onto one or more photosensitive media.

According to an embodiment a master RGB hologram may be copied onto a single photosensitive medium.

According to an embodiment a master RGB hologram may be copied onto a plurality of photosensitive media wherein the plurality of photosensitive media are then subsequently laminated to provide a single composite RGB copy hologram.

According to an embodiment separate red, green and blue master holograms may be copied onto a single photosensitive medium.

According to an embodiment separate red, green and blue master holograms may be copied onto a plurality of photosensitive media wherein the plurality of photosensitive media are subsequently laminated to provide a single composite RGB copy hologram.

Other embodiments are contemplated wherein a first RG, GB or RB master hologram together with a second R, G or B master hologram are copied to provide a first RG, GB or RB copy hologram together with a second R, G or B copy hologram. The first and second copy holograms are then preferably laminated together to provide a single composite RGB copy hologram.

According to another aspect of the present invention there is provided a method of copying a hologram comprising:

providing a pulsed laser source, the pulsed laser source comprising a first oscillator comprising a first active medium, wherein the first oscillator has a cavity length <200 mm; and

using the pulsed laser source to copy a hologram.

According to another aspect of the present invention there is provided a combined holographic printer and hologram copier system comprising:

a pulsed laser source, the pulsed laser source comprising a first oscillator comprising a first active medium wherein the first oscillator has a cavity length <200 mm and wherein the pulsed laser source is arranged to produce a first laser beam at a first wavelength;

a first reflective spatial light modulator;

a first lens system; and

positioning means for positioning a photosensitive medium downstream of the first lens system;

wherein in a first mode of operation the system operates as a holographic printer wherein'the first laser beam is split, in use, into a first object beam and a first reference beam which is mutually coherent with the first object beam, and wherein the first reflective spatial light modulator encodes data onto the first object beam and wherein the first lens system writes a holographic pixel of a hologram onto a photosensitive medium which is arranged, in use, downstream of the first lens system; and

wherein in a second mode of operation the system operates as a hologram copier wherein a master hologram is brought into contact with an unexposed holographic film or plate and wherein the master hologram is exposed to the first laser beam and a copy of the master hologram is written on the holographic film or plate.

According to another aspect of the present invention there is provided a method of printing a hologram and copying a hologram comprising:

providing a pulsed laser source, the pulsed laser source comprising a first oscillator comprising a first active medium wherein the first oscillator has a cavity length <200 mm and wherein the pulsed laser source produces a first laser beam at a first wavelength;

providing a first reflective spatial light modulator;

providing a first lens system; and

positioning a photosensitive medium downstream of the first lens system;

wherein in a first mode of operation the method comprises: (i) splitting the first laser beam into a first object beam and a first reference beam which is mutually coherent with the first object beam; (ii) encoding data onto the first object beam using the first reflective spatial light modulator; and (iii) writing a holographic pixel of a hologram onto a photosensitive medium which is arranged downstream of the first lens system; and

wherein in a second mode of operation the method comprises: (i) bringing a master hologram into contact with an unexposed holographic film or plate; (ii) exposing the master hologram to the first laser beam; and (iii) writing a copy of the master hologram on the holographic film or plate.

According to another aspect of the present invention there is provided a pulsed laser source for a holographic printer comprising a first oscillator comprising a first active medium and/or a second oscillator comprising a second active medium and/or a third oscillator comprising a third active medium, wherein the first oscillator and/or the second oscillator and/or the third oscillator have a cavity length <200 mm.

According to another aspect of the present invention there is provided a method of generating a pulsed laser beam for use by a holographic printer comprising:

providing a first oscillator comprising a first active medium and/or a second oscillator comprising a second active medium and/or a third oscillator comprising a third active medium, wherein the first oscillator and/or the second oscillator and/or the third oscillator has a cavity length <200 mm; and

generating a pulsed laser beam.

According to another aspect of the present invention there is provided a hologram copier comprising a pulsed laser source which outputs, in use, laser radiation at a first wavelength, wherein the hologram copier is arranged to copy a master hologram to form a copy hologram, wherein the master hologram comprises a first group of holopixels which were written substantially at the first wavelength and which have an optimal replay substantially at the first wavelength;

wherein the hologram copier comprises:

means for bringing the master hologram into contact with a photosensitive medium or substrate;

means for illuminating the master hologram with laser radiation from the pulsed laser source at the first wavelength; and

means for controlling the humidity of the photosensitive medium or substrate and/or the temperature of the photosensitive medium or substrate and/or the chemical processing of the photosensitive medium or substrate, wherein the means for controlling the humidity of the photosensitive medium or substrate and/or the temperature of the photosensitive medium or substrate and/or the chemical processing of the photosensitive medium or substrate is arranged to cause the copy hologram to be formed in or on the photosensitive medium or substrate and wherein the copy hologram comprises a second group of holopixels which have an optimal replay at a second wavelength which is substantially different from the first wavelength.

The difference between the first wavelength and the second wavelength is preferably selected from the group consisting of: (i) <10 nm; (ii) 10-20 nm; (iii) 20-30 nm; (iv) 30-40 nm; (v) 40-50 nm; (vi) 50-60 nm; (vii) 60-70 nm; (viii) 70-80 nm; (ix) 80-90 nm; (x) 90-100 nm; and (xi) >100 nm.

The first group of holopixels are preferably written by a first reference beam substantially at a first angle and with a first beam geometry. The means for illuminating the master hologram with laser radiation from the pulsed laser source at the first wavelength is preferably arranged to illuminate the master hologram with laser radiation from the pulsed laser source at the first wavelength and at substantially the first angle and/or with substantially the first beam geometry.

The pulsed laser source preferably additionally outputs, in use, laser radiation at a third wavelength. The master hologram preferably further comprises a third group of holopixels which are substantially written at the third wavelength and which have an optimal replay substantially at the third wavelength. The means for controlling the humidity of the photosensitive medium or substrate and/or the temperature of the photosensitive medium or substrate and/or the chemical processing of the photosensitive medium or substrate is preferably arranged to cause the copy hologram to be formed in or on the photosensitive medium or substrate and wherein the copy hologram preferably comprises a fourth group of holopixels which have an optimal replay at a fourth wavelength which is substantially different from the third wavelength.

The difference between the third wavelength and the fourth wavelength is preferably selected from the group consisting of: (i) <10 nm; (ii) 10-20 nm; (iii) 20-30 nm; (iv) 30-40 nm; (v) 40-50 nm; (vi) 50-60 nm; (vii) 60-70 nm; (viii) 70-80 nm; (ix) 80-90 nm; (x) 90-100 nm; and (xi) >100 nm.

The third group of holopixels are preferably written by a second reference beam substantially at a second angle and with a second beam geometry. The means for illuminating the master hologram with laser radiation from the pulsed laser source at the third wavelength is preferably arranged to illuminate the master hologram with laser radiation from the pulsed laser source at the third wavelength and at substantially the second angle and/or with substantially the second beam geometry.

The pulsed laser source preferably additionally outputs, in use, laser radiation at a fifth wavelength. The master hologram preferably further comprises a fifth group of holopixels which are substantially written at the fifth wavelength and which have an optimal replay substantially at the fifth wavelength. The means for controlling the humidity of the photosensitive medium or substrate and/or the temperature of the photosensitive medium or substrate and/or the chemical processing of the photosensitive medium or substrate is preferably arranged to cause the copy hologram to be formed in or on the photosensitive medium or substrate and wherein the copy hologram preferably comprises a sixth group of holopixels which have an optimal replay at a sixth wavelength which is substantially different from the fifth wavelength.

The difference between the fifth wavelength and the sixth wavelength is preferably selected from the group consisting of: (i) <10 nm; (ii) 10-20 nm; (iii) 20-30 nm; (iv) 30-40 nm; (v) 40-50 nm; (vi) 50-60 nm; (vii) 60-70 nm; (viii) 70-80 nm; (ix) 80-90 nm; (x) 90-100 nm; and (xi) >100 nm.

The fifth group of holopixels are preferably written by a third reference beam substantially at a third angle and with a third beam geometry. The means for illuminating the master hologram with laser radiation from the pulsed laser source at the fifth wavelength is preferably arranged to illuminate the master hologram with laser radiation from the pulsed laser source at the fifth wavelength and at substantially the third angle and/or with substantially the third beam geometry.

The pulsed laser source preferably comprises a first oscillator and/or a second oscillator and/or a third oscillator.

The first oscillator and/or the second oscillator and/or the third oscillator preferably have a cavity length selected from the group consisting of: (i) <50 mm; (ii) 50-60 mm; (iii) 60-70 mm; (iv) 70-80 mm; (v) 80-90 mm; (vi) 90-100 mm; (vii) 100-110 mm; (viii) 110-120 mm; (ix) 120-130 mm; (x) 130-140 mm; (xi) 140-150 mm; (xii) 150-160 mm; (xiii) 160-170 mm; (xiv) 170-180 mm; (xv) 180-190 mm; and (xvi) 190-200 mm.

According to another embodiment the first oscillator and/or the second oscillator and/or the third oscillator may have a cavity length selected from the group consisting of: (i) 200-250 mm; (ii) 250-300 mm; (iii) 300-350 mm; (iv) 350-400 mm; (v) 400-450 mm; (vi) 450-500 mm; and (vii) >500 mm.

The hologram copier preferably uses a 1D line scanning pattern and/or a 2D spot scanning pattern.

According to another aspect of the present invention there is provided a method of copying a hologram comprising:

providing a hologram copier comprising a pulsed laser source which outputs laser radiation at a first wavelength, wherein the hologram copier is arranged to copy a master hologram to form a copy hologram, wherein the master hologram comprises a first group of holopixels which were written substantially at the first wavelength and which have an optimal replay substantially at the first wavelength;

bringing the master hologram into contact with a photosensitive medium or substrate;

illuminating the master hologram with laser radiation from the pulsed laser source at the first wavelength; and

controlling the humidity of the photosensitive medium or substrate and/or the temperature of the photosensitive medium or substrate and/or the chemical processing of the photosensitive medium or substrate so as to cause the copy hologram to be formed in or on the photosensitive medium or substrate and wherein the copy hologram comprises a second group of holopixels which have an optimal replay at a second wavelength which is substantially different from the first wavelength.

Reflective Liquid Crystal on Silicon (“LCOS”) displays are commercially available and these displays have a relatively high efficiency and contrast. According to a preferred embodiment a holographic printer is provided which has a relatively low energy laser source and which uses a reflective display. The reflective display preferably comprises a LCOS display.

According to an embodiment a digital holographic printer is provided comprising one or more reflective SLMs and/or one or more lamp-pumped Q-switched SLM TEM₀₀ nanosecond short-cavity pulsed lasers.

A short-cavity pulsed laser preferably has a cavity length <200 mm.

According to an embodiment a digital holographic printer is provided comprising one or more reflective SLMs and/or one or more low energy diode-pumped Q-switched SLM TEM₀₀ nanosecond short-cavity pulsed lasers.

The preferred embodiment preferably comprises an improved object-beam digital-data encoding system that uses one or more reflective SLM displays and conveniently and efficiently allows a low energy pulsed laser beam of a given colour to be encoded with digital data that is then used to write a holographic pixel.

According to an embodiment a lamp-pumped Q-switched SLM TEM₀₀ nanosecond pulsed laser is provided which produces a highly stable emission in the green spectral region.

According to an embodiment a lamp-pumped Q-switched SLM TEM₀₀ nanosecond pulsed laser is provided which produces a highly stable emission in the red spectral region.

According to an embodiment a lamp-pumped Q-switched SLM TEM₀₀ nanosecond pulsed laser is provided which produces a highly stable emission in the blue spectral region.

According to another embodiment a diode-pumped Q-switched SLM TEM₀₀ nanosecond pulsed laser is provided which produces a highly stable emission in the green spectral region.

According to another embodiment a diode-pumped Q-switched SLM TEM₀₀ nanosecond pulsed laser is provided which produces a highly stable emission in the red spectral region.

According to another embodiment a diode-pumped Q-switched SLM TEM₀₀ nanosecond pulsed laser is provided which produces a highly stable emission in the blue spectral region.

According to an embodiment a holographic contact copier is provided that uses a short-cavity RGB TEM₀₀ SLM pulsed laser and a 2-D scanning pattern. The short-cavity red, green and blue TEM₀₀ SLM pulsed lasers are preferably the same lasers that are employed in a master holographic printer. The short-cavity laser preferably has a cavity length of <200 mm.

According to an embodiment a holographic contact copier is provided that uses an amplified short-cavity RGB TEM₀₀ SLM pulsed laser and a 1-D line-scanning pattern.

According to an embodiment a 2-step combined holographic master printer and 2-D scanning copier is provided. The copier preferably uses the same short-cavity lamp-pumped red, green and blue TEM₀₀ SLM pulsed lasers that are also employed in the master printer.

According to a less preferred embodiment a holographic contact copier is provided that uses a long-cavity RGB TEM₀₀ SLM pulsed laser and a 1-D or 2-D linescanning pattern.

According to an embodiment a combined 2-step holographic master printer and 2-D scanning copier is provided wherein the copier uses the same short-cavity diode-pumped red, green and blue TEM₀₀ SLM pulsed lasers that are also employed in the holographic master printer.

According to an embodiment the short-cavity laser has a cavity length <200 mm. The long-cavity laser preferably has a cavity length >200 mm.

Various embodiments of the present invention will now be described, by way of example only, and with reference to the accompanying drawings in which:

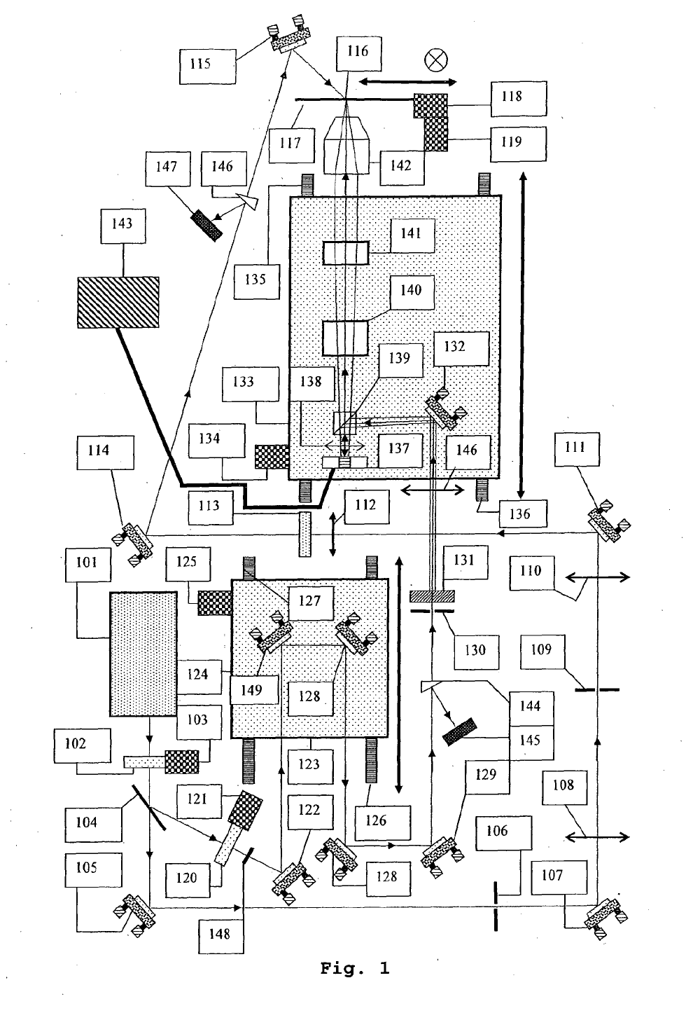

FIG. 1 shows a holographic printer according to a preferred embodiment;

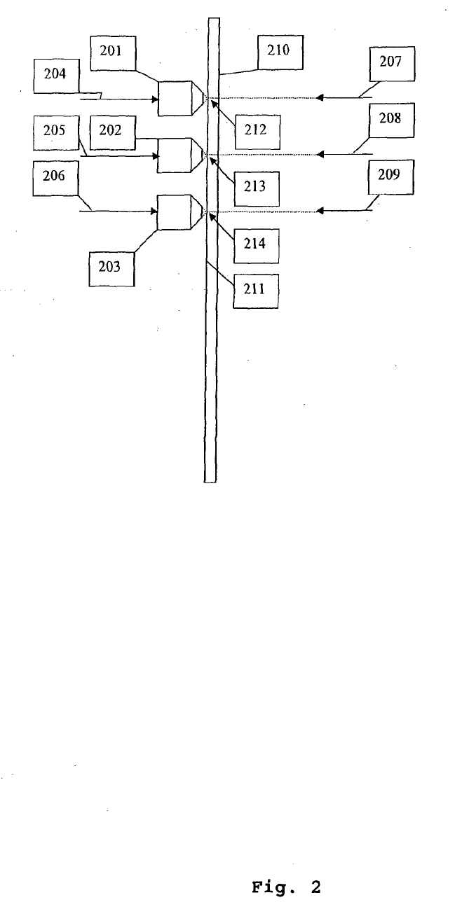

FIG. 2 shows a side view of a photosensitive glass plate together with red, green and blue objective lenses;

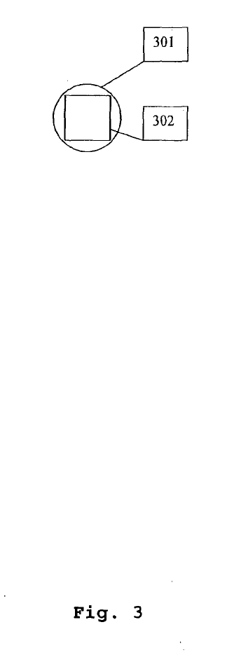

FIG. 3 shows the footprint of the object and reference beams for a given holographic pixel at the surface of a photosensitive material;

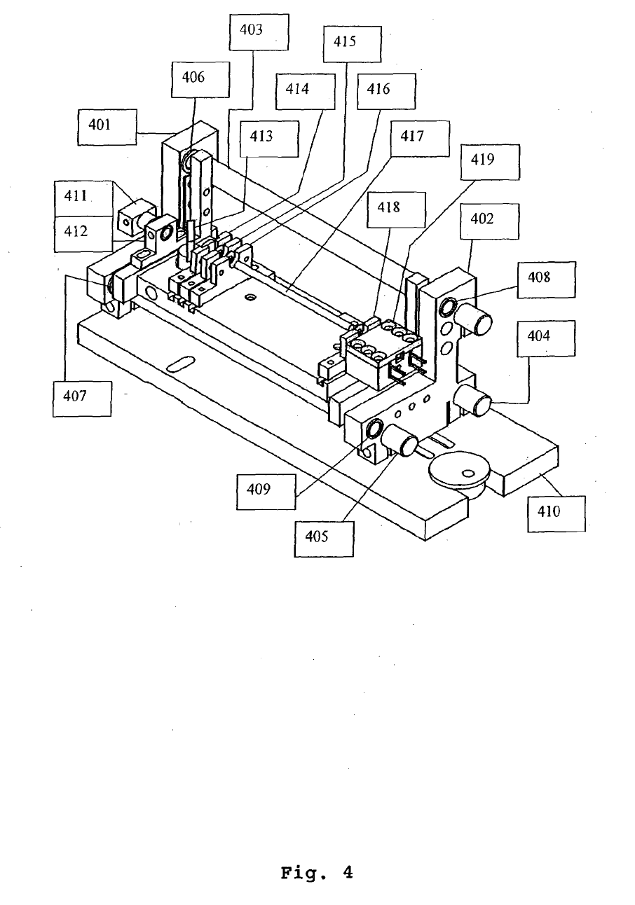

FIG. 4 shows a preferred short-cavity pulsed laser oscillator which may be operated at either 1064 nm or 1319 nm with the laser pump chamber removed;

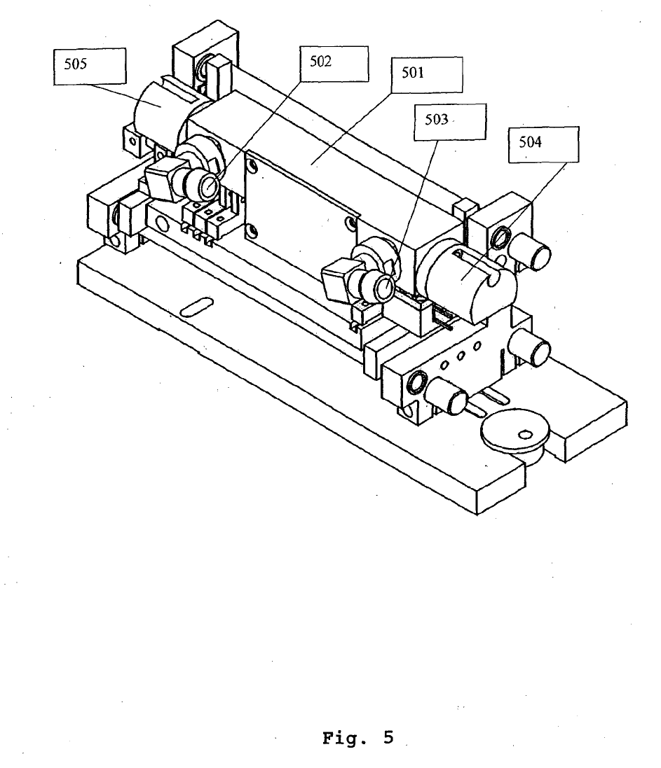

FIG. 5 shows a preferred short-cavity pulsed laser oscillator which may be operated at either 1064 nm or 1319 nm with the pump chamber visible;

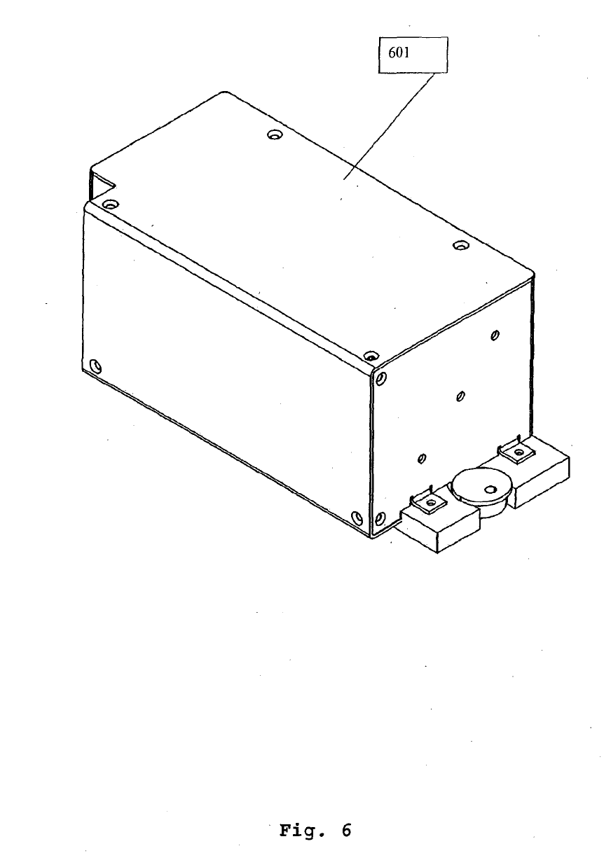

FIG. 6 shows a preferred short-cavity pulsed laser oscillator which may be operated at either 1064 nm or 1319 nm housed within a tightly fitting aluminium case;

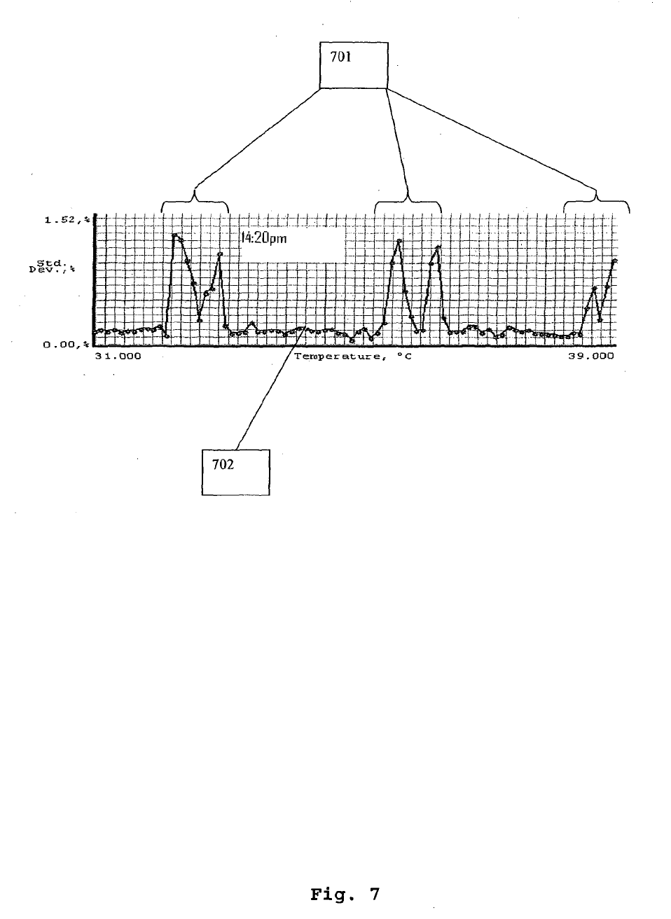

FIG. 7 shows a graph of the standard deviation of the energy of laser output versus rear-mirror mount temperature for a laser source operating at 1064 nm;

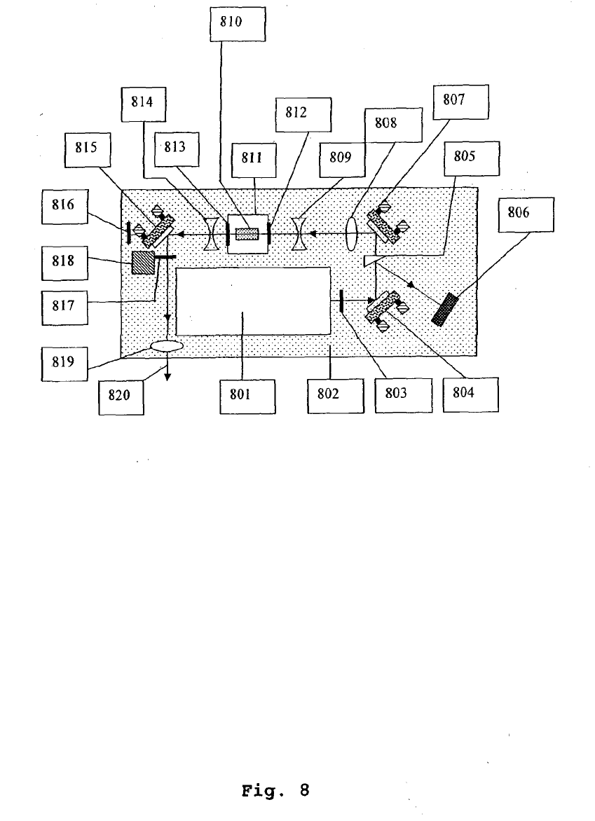

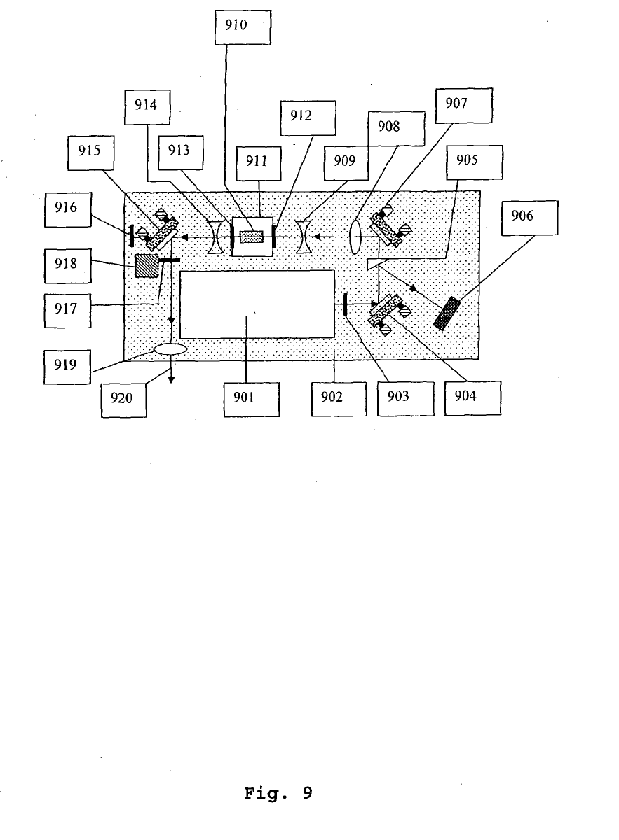

FIG. 8 shows a laser source according to a preferred embodiment which emits a laser beam at 532 nm;

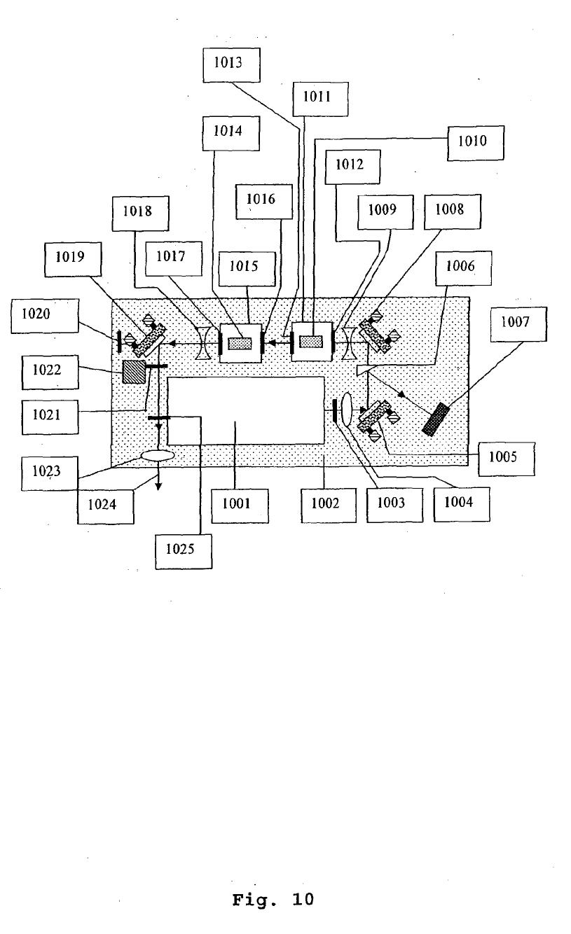

FIG. 9 shows a laser source according to a preferred embodiment which emits a laser beam at 660 nm;

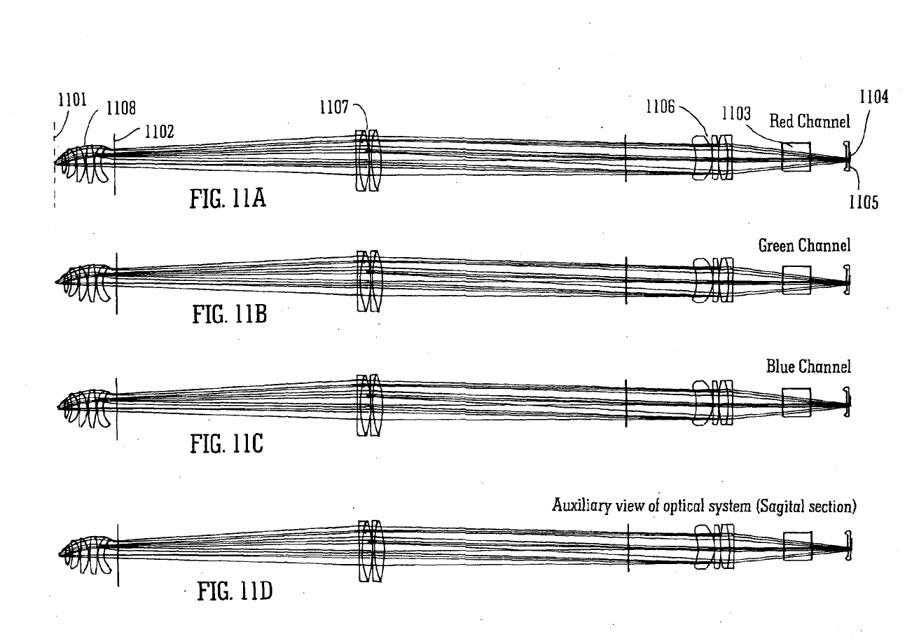

FIG. 10 shows a laser source according to a preferred embodiment which emits a laser beam at 440 nm;

FIG. 11 shows ray-tracing diagrams through a LCOS display, an afocal telecentric reversing system and a high NA objective for each colour channel according to an embodiment of the present invention;

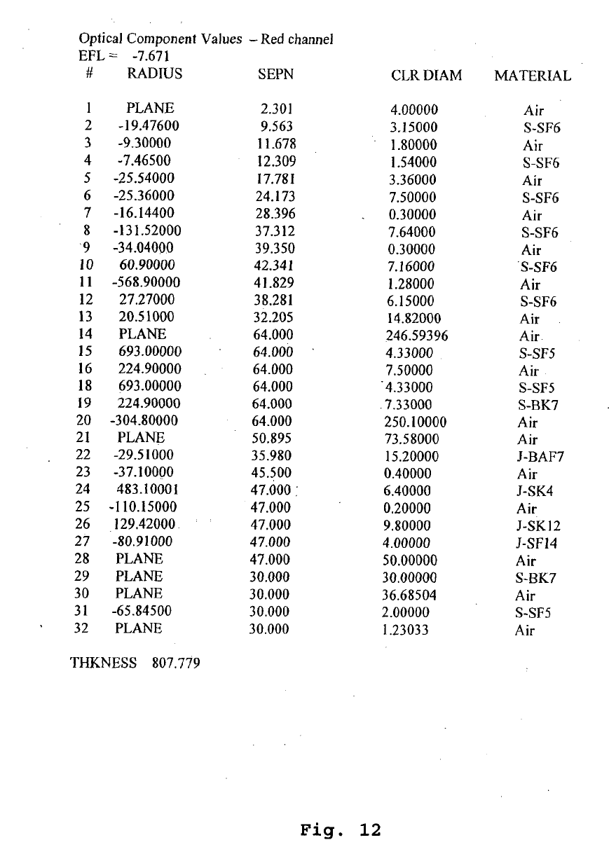

FIG. 12 itemises the optical component values for the components shown in FIG. 11 for the red channel;

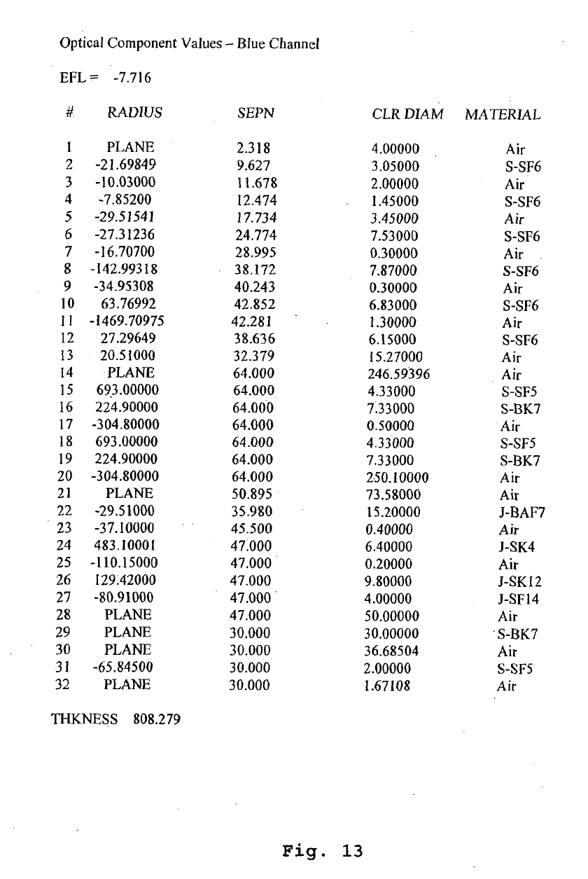

FIG. 13 itemises the optical component values for the components shown in FIG. 11 for the blue channel;

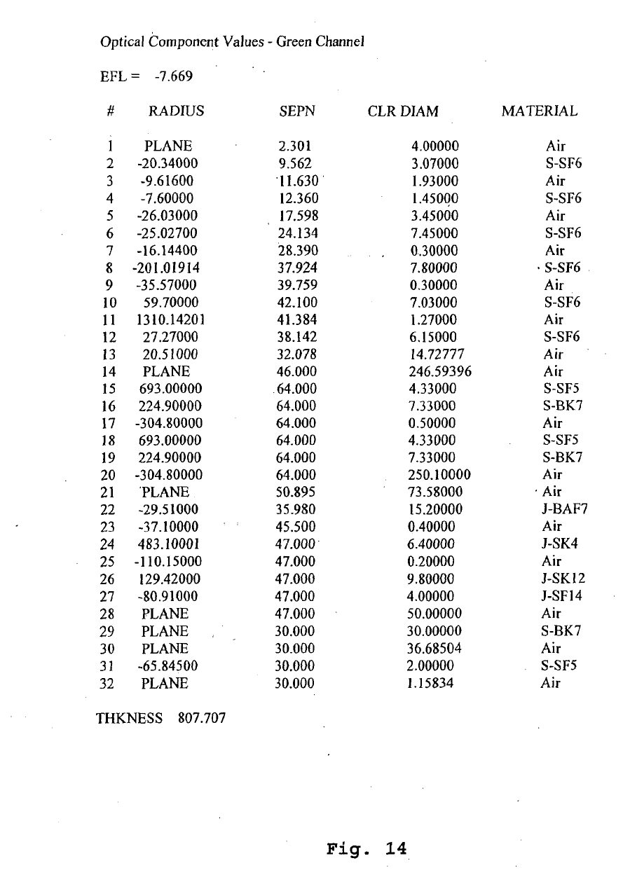

FIG. 14 itemises the optical component values for the components shown in FIG. 11 for the green channel;

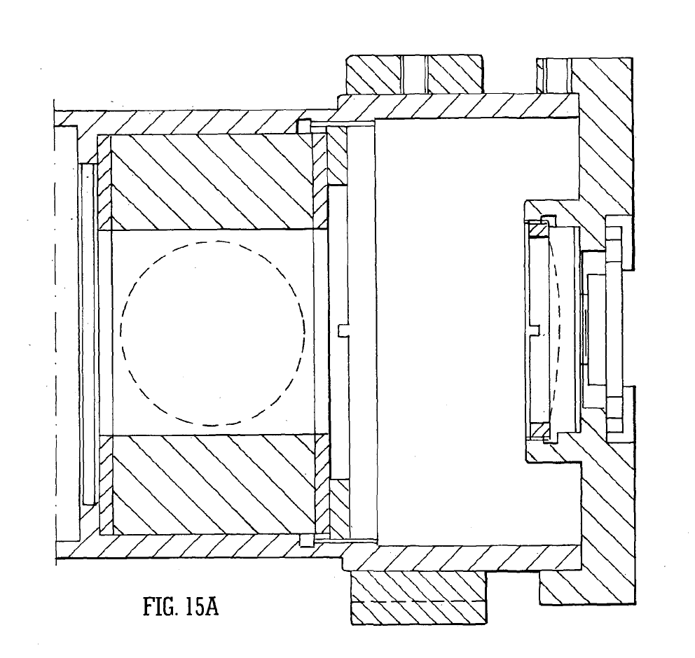

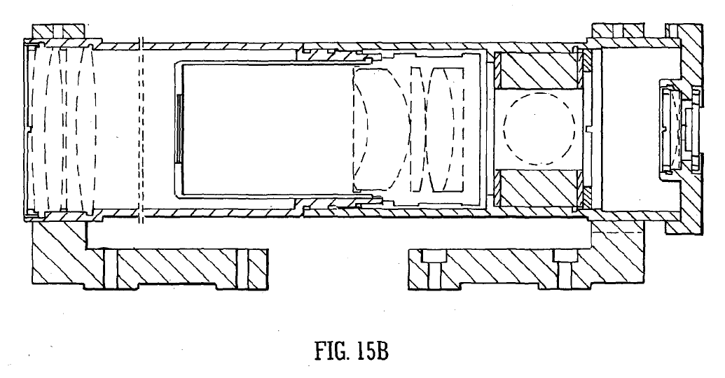

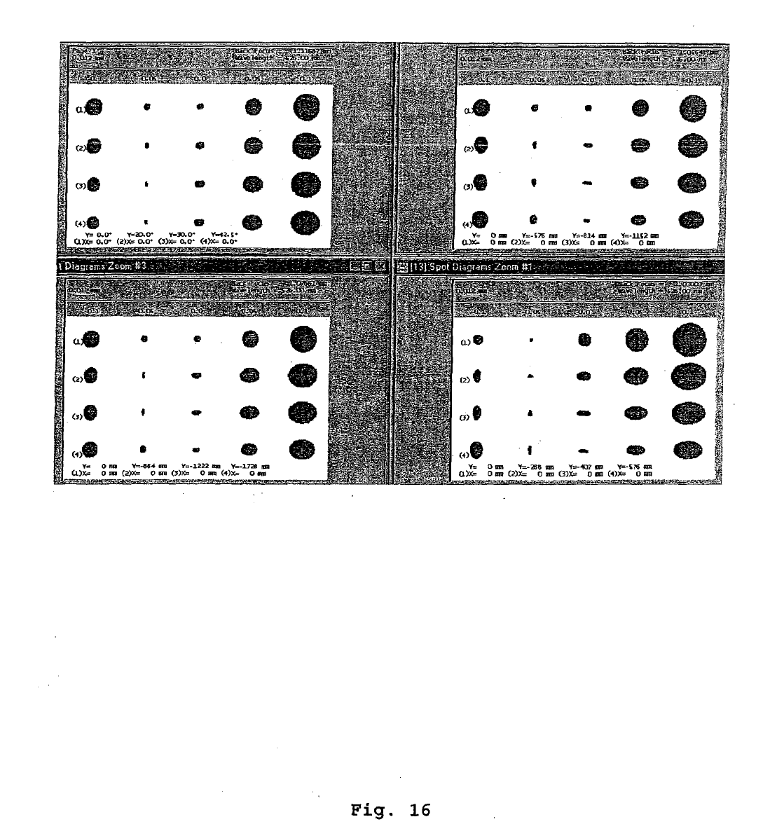

FIG. 15 shows the mounting system for the LCOS display, field curvature lens, polarising cube and afocal telecentric reversing system for the red channel;

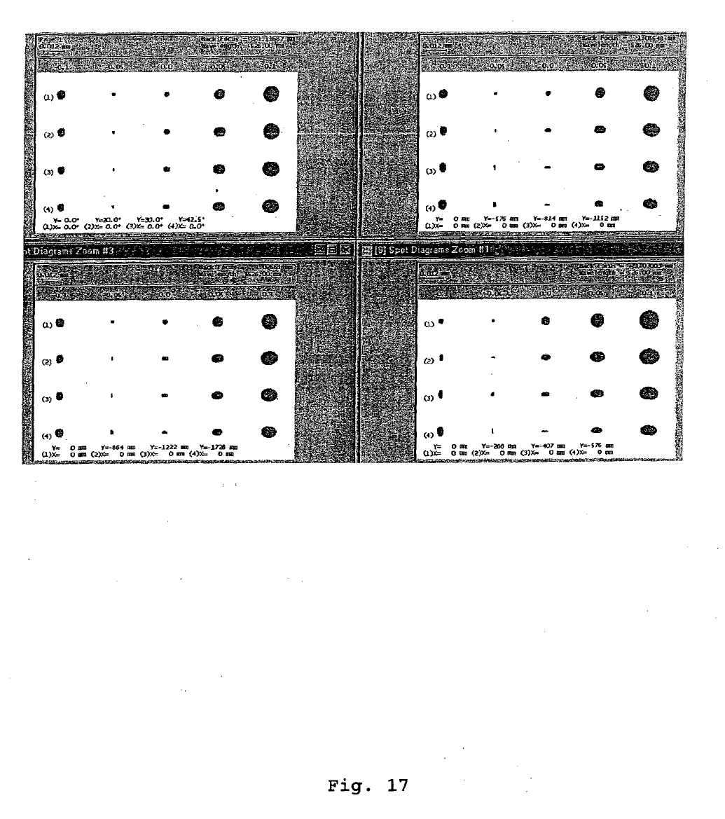

FIG. 16 shows spot diagrams at a LCOS display surface for 1 mm pixels;

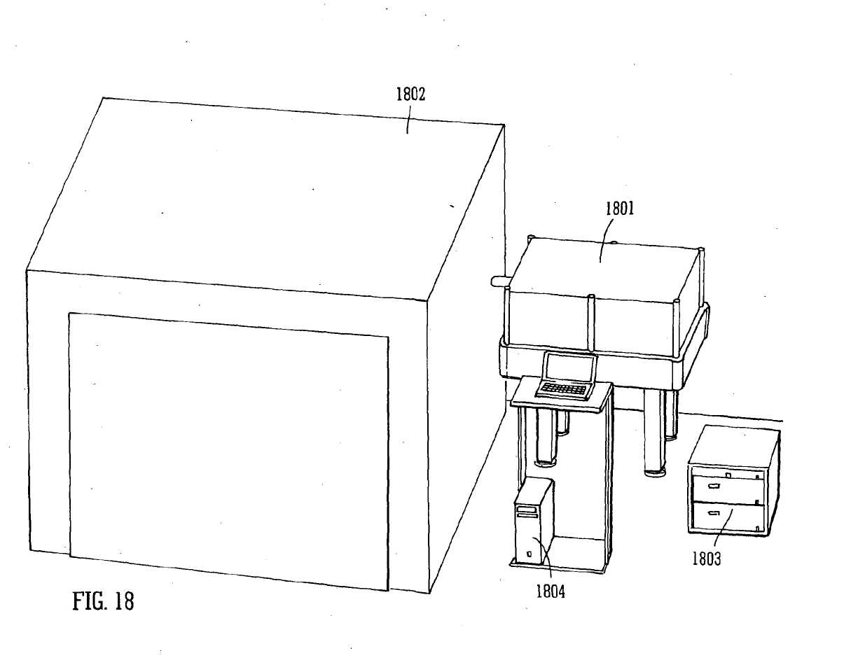

FIG. 17 shows spot diagrams at a LCOS display surface for 0.5 mm pixels;

FIG. 18 shows a general view of a hologram copier according to an embodiment;

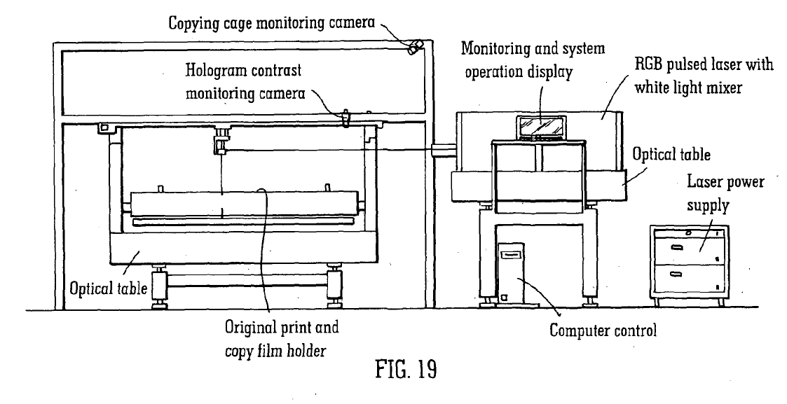

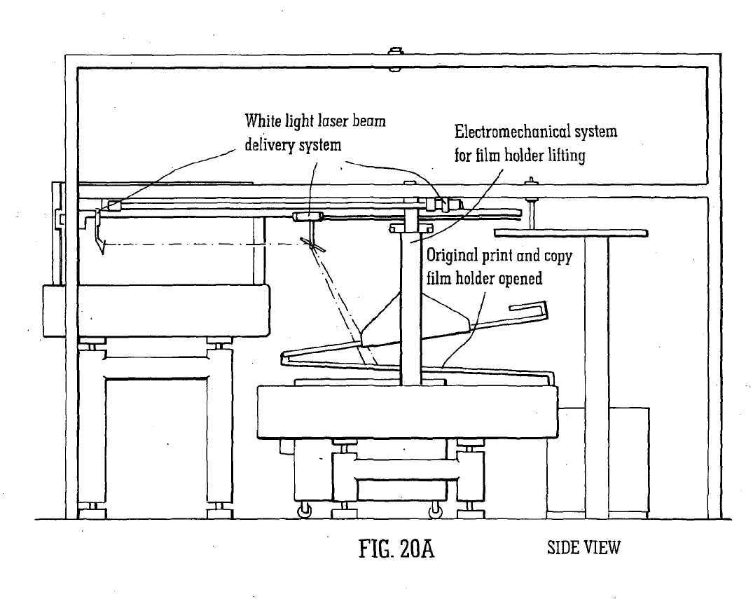

FIG. 19 shows a front view of a hologram copier according to an embodiment;

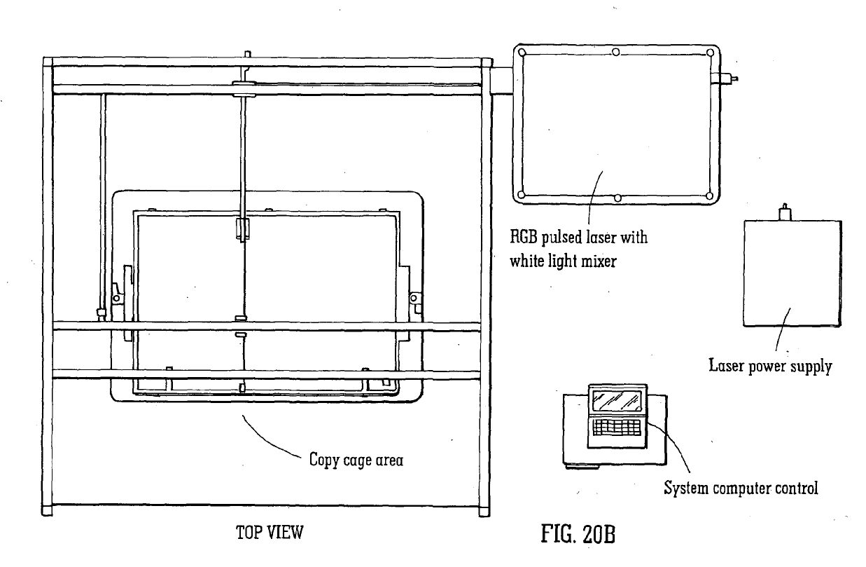

FIG. 20A shows a side view of a hologram copier according to an embodiment and FIG. 20B shows a plan view of a hologram copier according to an embodiment;

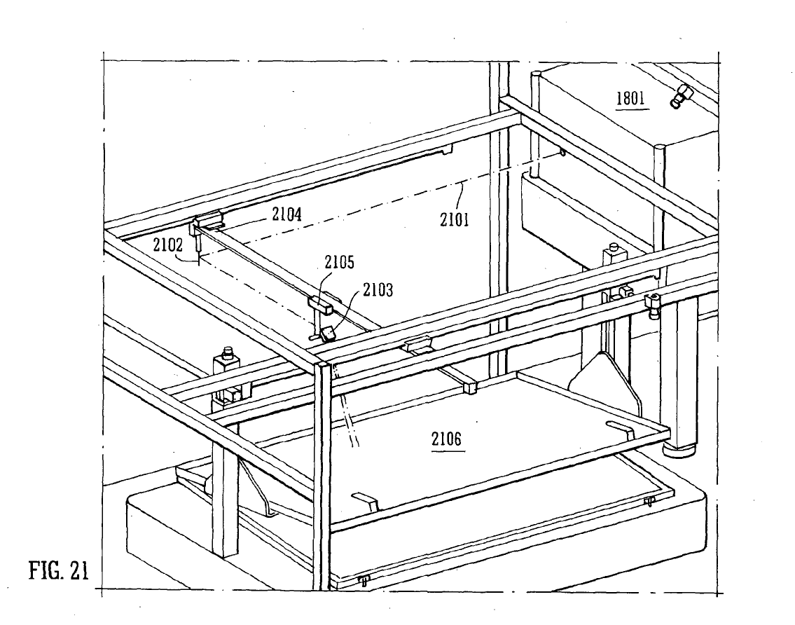

FIG. 21 shows a beam delivery system and film holder lifting mechanism of a hologram copier according to an embodiment;

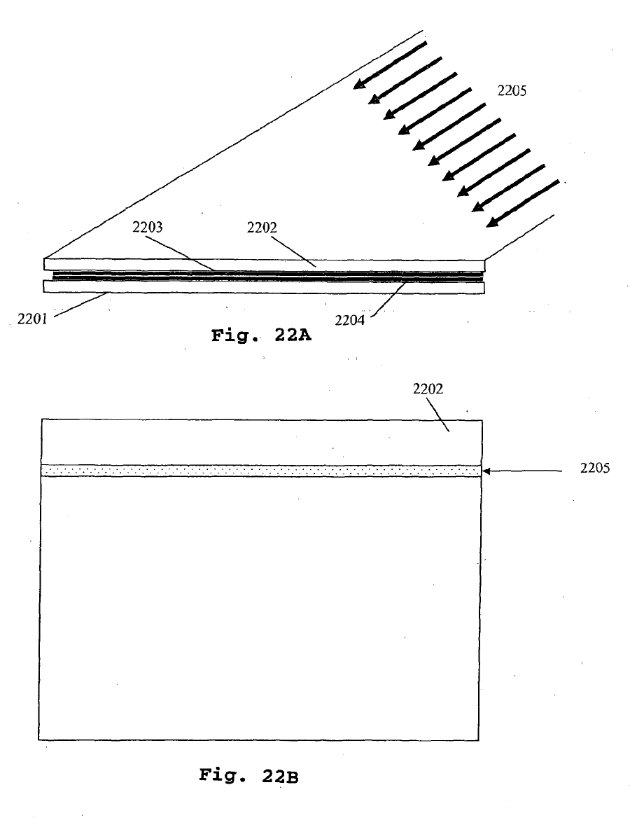

FIG. 22A shows a side view of a film sandwich and FIG. 22B shows a side view of FIG. 22A;

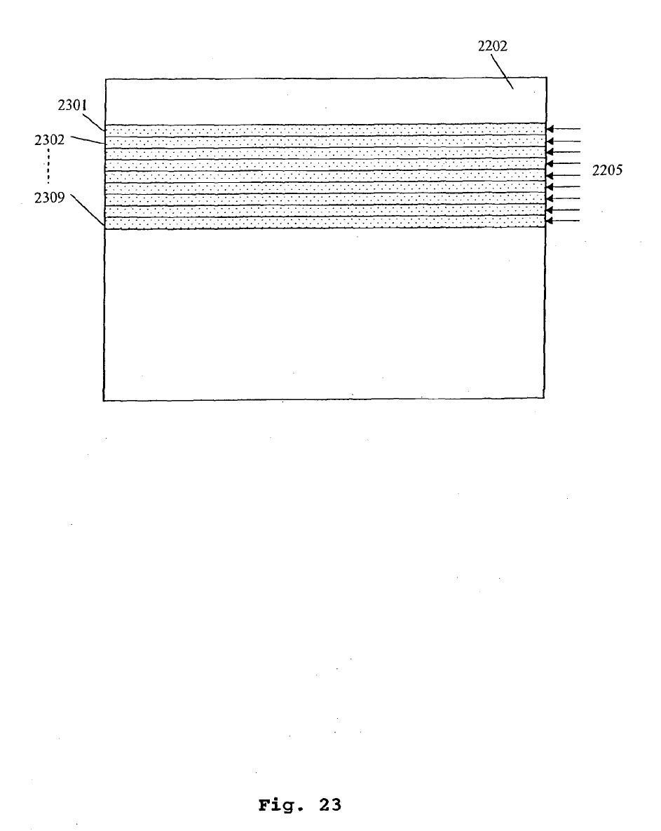

FIG. 23 shows a preferred scanning procedure;

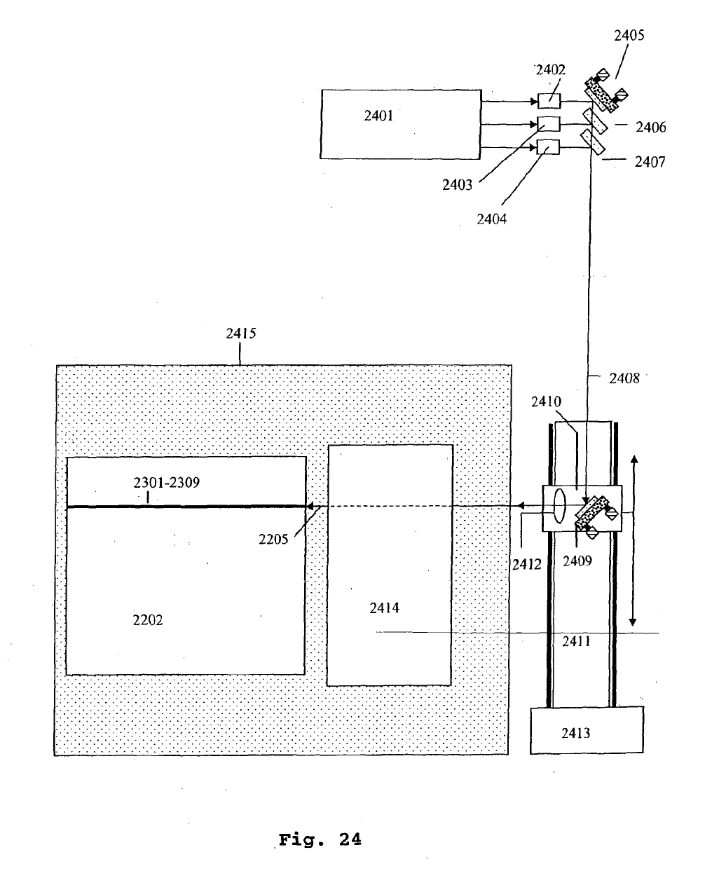

FIG. 24 shows a plan view of a preferred hologram copier; and

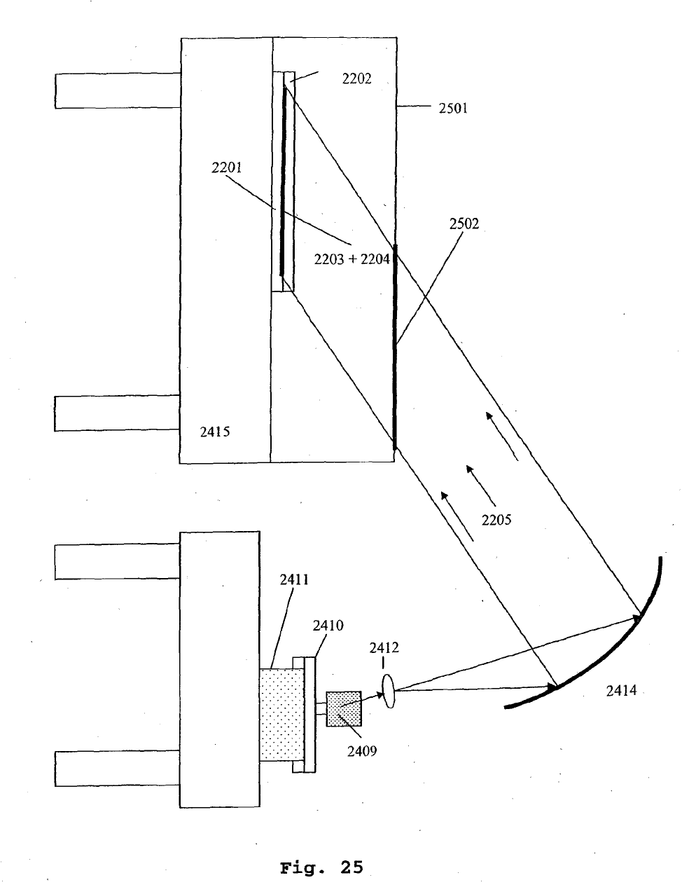

FIG. 25 shows a side view of a preferred copying system.

A schematic diagram of a digital holographic printer according to a preferred embodiment of the present invention is shown in FIG. 1. For the sake of clarity, only one laser source and corresponding optics is shown. The complete holographic printer preferably comprises three separate pulsed lasers which respectively produce red, green and red laser outputs. The optical schematic for each colour channel or laser source is preferably substantially the same. The three laser sources and corresponding optics are preferably stacked one above the other.

The holographic printer preferably takes digital data from a 3D visualisation and creation program such as 3D Studio Max®. A computer preferably performs pixel swapping transformations on the image data before supplying the converted and/or corrected data to the holographic printer.

The holographic printer preferably writes composite holograms composed of a regular two-dimensional array of holographic pixels onto a film or glass photosensitive material using three pulsed laser sources emitting respectively red, green and blue laser beams.

Each holographic pixel, which is preferably between 0.25 mm and 1 mm in diameter, is preferably formed by intersecting object and reference beams. The data for the object beam is preferably encoded onto the object beam using a reflective LCOS panel. Pixel-swapped image data is preferably displayed on the LCOS panel.

A two-dimensional array of holographic pixels is preferably written onto the photosensitive medium by causing the photosensitive material to move in a two-dimensional fashion through the pixel focus. In this way a full image is built up dot-matrix style on the photosensitive material.

The complete holographic printer preferably comprises three laser sources. One laser source preferably emits a red (660 nm) laser beam, one laser source preferably emits a green (532 nm) laser beam and one laser source preferably emits a blue (440 nm) laser beam. The beam-paths for the three colours are preferably stacked identically one on top of the other.

FIG. 1 shows a red laser source and corresponding optics. A short cavity 1319 nm TEM₀₀ SLM laser 101 is preferably provided. The output of the laser is preferably frequency converted to 660 nm. The output is preferably emitted as a pulsed laser beam which is preferably 3 mm diameter and preferably has an energy of 0.3 mJ. The laser beam preferably traverses a half-waveplate 102. The half-waveplate 102 is preferably mounted in a precision rotation stage that is preferably controlled by a stepper motor 103 connected to the system control computer.

The laser beam preferably passes on to a Brewster angle polarizer 104 where it is preferably split into a reference beam and an object beam. Two energy meters 147,145 preferably measure the energies in these two beams. By activating the stepper motor 103 the system control computer can control accurately the reference beam energy.

### Object Beam

The object beam preferably originates at the polarizer 104 and preferably traverses a half-waveplate 120 which is preferably controlled by a stepping motor 121. The object beam then preferably traverses a Brewster angle polarizer (down-facing) 148 where excess energy in the wrong polarization is preferably dumped. A mirror 122 preferably guides the object beam onto two mirrors 149,128 arranged in series which are preferably mounted on a precision translation stage 124. The translation stage 124 is preferably mounted on precision rails 126,127 and is preferably controlled by a stepping motor 125. The system control computer can preferably control the beam path length of the object beam by controlling the stepping motor 125. As the translation stage 124 moves back and forth, the beam directions preferably remain invariant but the beam path length preferably changes. This allows the object and reference beam paths to be matched exactly.

The object beam is then preferably reflected by mirrors 128,129 before traversing a coated wedge 144. The wedge 144 is preferably cut at 10° and its rear-surface is preferably anti-reflection coated at 660 nm for the red object beam. The corresponding wedge in the blue channel is preferably anti-reflection coated at 440 nm for the blue object beam and the corresponding wedge in the green channel is preferably anti-reflection coated at 532 nm for the green object beam. The wedge 144 preferably allows most of the object beam to traverse it unchanged whilst reflecting'a few percent of the object beam to an energy meter 145 such as a GEM-SI-7511 energy meter 145 (commercially available from Geola Group). The energy meter 145 is preferably calibrated to read the object beam energy and is preferably connected via a USB cable to the system control computer.

The object beam preferably continues to an aperture 130 and a microlens array 131. The shape and size of the aperture 130 preferably determines the shape and size of the final holographic pixel 116. The aperture 130 preferably is a square shape. An aperture dimension of 9 mm×9 mm preferably corresponds to a holographic pixel size of 1 mm×1 mm at the photosensitive film 117.

Various different microlens arrays 131 may be used depending upon the LCOS display 137 panel used. For example, if a BR768HC display panel is used (available from HOLOEYE and made by Brillian) then a microlens array which is preferably 50 mm in diameter and made from BK7 (or K8) may be used. The lens array preferably comprises rectangularly packed 0.2 mm×0.23 mm lenslets each having a radius of curvature of 0.65 mm. On illumination by the squarely apodised object beam the microlens array preferably produces a beam having a rectangular beam profile downstream. This profile is preferably chosen (through the design of the microlens array 131) to fit or match the LCOS display 137.

Other microlens arrays may be used in conjunction with different LCOS displays. For example, rectangularly packed lenslets 0.1 mm×0.115 mm having a radius of curvature of 0.335 mm may be used. Also, rectangularly packed lenslets 0.4 mm×0.46 mm having a radius of curvature of 1.3 mm may be used. According to another embodiment a randomly packed microlens array may be used.

The object beam downstream of the microlens array 131 is preferably conditioned by one or more lenses 146 and is then preferably reflected by a mirror 132 onto a polarizing beamsplitter 139 which is preferably a McNeale type polarizing beamsplitter. The light is preferably reflected by the polarizing beamsplitter 139 and preferably passes through a field curvature correction lens 138 and then preferably illuminates a relatively small LCOS panel 137. Various different panels may be used but a BR768HC panel is particularly preferred. A BR768HC panel measures 17.91 mm diagonal, has a 12 micron pixel pitch, a fill factor of 92%, a reflectivity of 71% and a frame rate of 120 Hz.

The object beam that is reflected from the LCOS panel 137 is preferably modulated by a digital image which is preferably supplied by the system control computer and is preferably derived from pixel-swapped image data.

Digital data is preferably encoded onto the object beam by the LCOS panel 137 as a phase modulation. When the object beam passes back through the polarizer 139 the phase modulation is preferably converted to an amplitude modulation. The amplitude modulated object beam then preferably passes through a telecentric afocal reversing system 140,141 before being focused to a holographic pixel 116 by a high numerical-aperture telecentric objective lens system 142.

The LCOS panel 137, the field curvature correction lens 138, the telecentric afocal reversing system 140,141, the polarizer cube 139 and the mirror 132 are all preferably mounted on a precision translation stage 133 having rails 135,136. The translation stage 133 is preferably controlled by a stepper motor 134.

The system control computer preferably uses a motor 134 to adjust the distance at which a focused real image of the LCOS panel 137 appears in space behind the photosensitive medium 117. This is preferably chosen to correspond to the viewing distance of the hologram being printed.

According to an alternative embodiment a Prof lux thin-wire polarizing beamsplitter may be used instead of a McNeale type polariser 139.

### Reference Beam

The reference beam preferably originates at the polarizer 104 and is preferably reflected by a mirror 105 to an aperture 106. The aperture 106 is preferably generally elliptical. An image of the aperture 106 is preferably formed by a lens system comprising three lenses 108,110,112 at the photosensitive film surface 116. Since the reference beam preferably intersects the photosensitive film at an angle (preferably close to 45 degrees) then the final reference beam footprint is preferably circular rather than elliptical.

The reference beam preferably passes through the aperture 106 and preferably reflects off a mirror 107. The reference beam then preferably passes through a lens 108 and a small pinhole 109 which is preferably 0.2-0.8 mm. The pinhole 109 preferably acts as a spatial filter and cleans up the beam. The energy is preferably relatively low such that electro-optical breakdown is preferably avoided. The pinhole 109 preferably removes high spatial frequencies and preferably softens the image of the aperture 106 at the film surface 116. In this way a Gaussian circular reference beam is preferably created at the holographic pixel location.

The reference beam preferably passes from the pinhole 109 through a lens 110. The beam is then preferably reflected off a mirror 111 and preferably traverses through a further lens 112. The reference beam then preferably passes to a polarizer 113 which preferably removes any unwanted polarization. The reference beam is then preferably reflected off a mirror 114. The reference beam then preferably passes to a wedge 146 which preferably reflects a few percent of the reference beam back to an energy meter 147 which preferably comprises a GEM-SI-7511 energy meter 147. This allows the system computer to monitor the reference beam energy. The rear side of the wedge 146 is preferably AR coated.

The reference beam then preferably continues on to a mirror 115 where the reference beam is then preferably reflected so as to intersect the photosensitive material 117 at a holographic pixel 116.

With reference to FIG. 3, the circular reference beam 301 is preferably arranged to be slightly larger than the square footprint 302 of the object beam at the photosensitive material surface. The centre axial rays of both the object and reference beams preferably intersect at the surface of the photosensitive material 117.

In order to increase optical efficiency all lenses and other relevant optics are preferably AR coated on both sides for the respective colour-channel wavelengths. Optional telescopes may be located between mirror 105 and aperture 106 in the reference beam and between mirror 129 and aperture 130 in the object beam in order to match the laser beam output diameter (for each respective colour channel) to that required by apertures 106,130 more precisely.

### Three Colour System

The optical scheme for the red colour beam has been described above with reference to FIG. 1. The overall holographic printer preferably comprises three similar optical schemes each stacked approximately 18 cm above the other as shown in FIG. 2. Three synchronized pulsed lasers are preferably provided. One laser pulse is preferably provided at 660 nm, one laser pulse is preferably provided at 440 nm and one laser pulse is preferably provided at 532 nm.

Three LCOS displays and three sets of optics are preferably provided. The three LCOS displays are preferably used to encode the red, green and blue (pixel-swapped) image data respectively onto the three object beams. Three objective lenses 201,202,203 are preferably mounted one above the other and preferably define three holographic pixels (red, green, blue). The red object beam 204 preferably intersects with a red reference beam 207, the blue object beam 205 preferably intersects with a blue reference beam 208, and the green object beam 206 preferably intersects with a green reference beam 209. The position of the intersection is preferably at the emulsion surface 211 of the photosensitive plate 210. The red pixel is preferably at 212, the blue pixel is preferably at 213 and the green pixel is preferably at 214.

At every synchronized laser pulse, a red, blue and a green holographic pixel are preferably written at separate locations on the photosensitive material 210. After each flash or pulse, the photosensitive material 210 is then preferably advanced horizontally using a motor 118 and another set of three holopixels are preferably written immediately next to the first set. This process is preferably repeated until the end of the row. A motor 119 then preferably advances the photosensitive material in the vertical direction by a distance equal to the width of the holopixels. Another row of pixels is then preferably written. This process preferably continues until the entire surface of the photosensitive material 210 has been covered with juxtaposing holopixels. By choosing the separation between the red, green and blue objectives to be a multiple of the holopixel width, every part of the photosensitive material will preferably contain exactly overlapping red, green and blue holopixels.

The operation of the holographic printer is preferably controlled by a system computer that is preferably connected to control and interface cards that preferably connect to the various stepper motors, energy meters, lasers and LCOS panels. A triggering system is preferably provided which preferably enables the laser to fire at an appropriate moment to record a holographic pixel. The lasers preferably fire at an approximately constant rate. To run at high speed the LCOS image frame is preferably loaded immediately after a laser pulse. A dedicated microcomputer with a large memory cache (frame loader unit) is preferably connected to the system control computer (where the pixel-swapped image data is stored) to take care of this task.

The 2-D stage controlling of the photosensitive material position is preferably controlled by an electronic unit (motion control unit) which preferably provides a trigger signal for the lasers. The fact that the lasers preferably operate at a nearly constant repetition rate means that the photosensitive material is preferably arranged to travel at a constant velocity during printing time. This in turn leads to the programming of acceleration and deceleration phases in which the photosensitive material is either brought up to speed or decelerated.

A 2-D stepper motor stage is preferably used to control the position of the photosensitive material. Either stepper or servo stages may be used for faster print speeds.

The movement of the 2-D stage controlling the photosensitive material position during a print cycle is preferably controlled by the motion control unit. The system computer preferably calculates the entire printing pattern for the hologram before the start of printing and preferably downloads certain information to the motion control unit. When printing starts, the motion control unit preferably controls the motion of the photosensitive material. The motion control unit preferably calculates when to send trigger pulses for the lasers to fire and also preferably instructs the frame loader unit when to load another frame.

### Printer Operation

Before printing a hologram the system computer preferably sets the optimum object and reference energies for each colour channel by adjustment of the motors 103,121 and with reference to the energy meters 145,147. A reference to object beam ratio of between 1:1 to 2:1 is preferably used depending upon the photosensitive emulsion. Panchromatic emulsion PFG-03CN available from Geola Group is preferably used. This emulsion preferably requires approximately 300 μJ/cm².

Before printing, the three lasers are preferably calibrated to ensure maximum energy stability and are preferably run continuously with their internal shutters closed.

The image data is preferably pixel-swapped and stored ready for writing on the system computer. In addition to pixel swapping, numerical correction for the optical distortion that is induced by the printer optics may also be corrected for.

The holographic printer preferably employs glass plates coated with a Silver Halide emulsion (such as PFG-03CN). The photosensitive material is preferably loaded and the two-dimensional stage, controlled by motors 118,119, preferably moves such that the first red, green and blue holopixels will be in the correct position for the start of printing.

The printer then preferably commences the printing process. The first red, green and blue data frames of pixel-swapped distortion-corrected image data are preferably loaded onto the LCOS display panels. The motor that advances the photosensitive material horizontally preferably starts to roll and achieves a constant horizontal velocity. When the photosensitive material reaches the position for the first pixel a trigger signal is preferably sent to the lasers. Upon receipt of this trigger, the three high-speed internal laser shutters preferably open and laser pulses preferably record the first red, green and blue holopixels.

The next frame is then preferably loaded onto the LCOS panels by the frame loader unit and when this has occurred a ready signal is preferably sent to the lasers. The photosensitive material preferably continues moving horizontally at a constant speed. When the photosensitive material reaches the correct position for the next holopixels the motion control unit preferably sends a signal to the lasers that causes them to fire a pulse and record further holopixels. This process preferably continues until a complete row of juxtaposed holopixels (red, green and blue) have been printed. At the end of the row, the laser shutters preferably close, the horizontal stage preferably stops and the vertical stage preferably raises the photosensitive material the width of a holopixel. The lasers then preferably resume operation. The holographic printer then preferably starts printing in the reverse direction in the manner as described above. The process preferably continues until the entire hologram has been printed.

The photosensitive material is preferably processed using standard chemical processing. Full-colour dot-matrix reflection holograms are preferably produced which are preferably used as master holograms for subsequent copying. Multiple copies may be generated quickly using a pulsed laser copier as will be described in more detail below. The reflection holograms may alternatively be used as high-quality stand-alone holograms in their own right.

The holographic printer preferably operates at 50 Hz. Any limitation in speed is due to the control electronics, the laser power supplies, the design of the laser pump chamber and the two-dimensional ISEL translation stage which is preferably used to move the photosensitive material. Other embodiments are contemplated wherein the print-speed may be increased to the preferred LCOS panel limit of 120 Hz. State of the art VAN LCOS panels are commercially available from Sony which would enable print speeds up to 200 Hz to be achieved.

### Pulsed Laser Sources

The holographic printer preferably comprises three pulsed lasers, one for each colour channel. Each pulsed laser source preferably comprises a relatively short cavity lamp-pumped oscillator. According to the preferred embodiment the oscillators preferably have a cavity length of 130 mm.

The red and blue laser sources preferably comprise an oscillator that emits at 1319 nm. The oscillator preferably comprises a crystal of Nd:YAG. The green laser source preferably comprises an oscillator that emits at 1064 nm. The oscillator preferably comprises a crystal of Nd:YAG.

The red laser source preferably uses frequency doubling to produce an output of 660 nm. The blue laser source preferably uses frequency tripling to produce an output at 440 nm. The green laser source preferably uses frequency doubling to produce an output at 532 nm.

A short cavity oscillator according to a preferred embodiment will now be described with reference to FIGS. 4-6.

### Green Laser Source Comprising 1064 nm Laser Oscillator

The green laser source preferably comprises a laser oscillator as shown in FIG. 4. The oscillator preferably comprises a linear resonator formed by a rear mirror 411,412 and an output coupler (shown enclosed in an temperature stabilised oven 419). Both of these components are preferably mounted on precision mounts 401,402 which are preferably held apart at a precise distance by three super-invar bars 403,404,405. The precision mounts preferably have vertical 406,408 and horizontal 407,409 precision adjusters operated by hex key for alignment of the laser cavity. The laser oscillator is preferably fixed to a laser breadboard by means of a mounting plate 410.

The rear-mirror 411,412 preferably comprises a flat fused silica HR laser-line dielectric mirror coated for 1064 nm having a reflectivity of >99.9%. The dielectric mirror is preferably mounted in a holder 411 that preferably comprises a hollow aluminium tube with a thermal insulating ring connected to a small hollow aluminium box in which the rear mirror is mounted. The holder 411 is preferably fixed using two precision screws into a receptor 412.

The holder 411 is preferably heated by small copper heating pads and a thermistor preferably measures the temperature. An electronic circuit preferably permits a laser control computer to change the holder temperature interactively thereby changing the laser cavity length.

The output coupler preferably comprises a 13 GHz uncoated BK7 etalon. The output coupler is preferably mounted in a precision temperature-controlled oven 419 in order to ensure stable laser frequency selection.

The active laser element preferably comprises an Nd:YAG rod 417 which preferably has a diameter of 3 mm and a length of 65 mm. The Nd:YAG rod is preferably AR coated at both ends for 1064 nm. The doping concentration is preferably 1.1% Ne. The Nd:YAG rod 417 is preferably mounted in a pump-chamber 501 (see FIG. 5). A 5×45 mm Xenon flashlamp (available from companies such as Perkins Elmer, Hereaus NobleLight or First Light) with an Samarium plate UV filter is preferably provided in the pump chamber 501. The pump chamber 501 preferably provides water cooling via connections 502 (IN) and 503 (OUT) to the active element. Electrical connections are preferably made through PTFE insulators 504,505. A diffuse ceramic diffuser is preferably used to reflect and focus the lamp light onto the active rod. Lamp power supplies similar to model PS5052 may be used which are available from Ekspla UAB. At 50 Hz and above it is preferred to use power supplies similar to the PS5052 that have improved voltage stability at these high repetition rates. A water-water PS1222C0 cooling unit from Ekspla may preferably be used. An additional air-water chiller may be used to supply chilled water at a constant temperature to the cooling unit.

With reference to FIG. 4, single polarization is preferably selected by a 1064 nm AR coated Brewster angle polarizer 413. Spatial hole burning is preferably avoided in the laser cavity by two AR coated (1064 nm) quarter-waveplates 416,418. Q-switching is preferably effected using a Cr:YAG crystal 414 having an initial transmission of 70% (AR coated for 1064 nm on both ends). TEM₀₀ mode generation is preferably obtained by using a 0.9 mm circular ground-glass aperture 415. The total cavity length is preferably 128 mm.

A tightly fitting aluminium case 601 (see FIG. 6) preferably fits around the laser oscillator. The case is preferably fitted with sixteen precision temperature control units which preferably control the temperature at sixteen roughly equally spaced points on the case to a precision of +/−0.01° C. The case is preferably thermally insulated.

The laser oscillator is preferably fixed firmly to an aluminium breadboard that forms the base of the larger laser case which also contains the frequency conversion optics. Twenty-eight precision temperature control units (precision +/−0.01° C.) are preferably mounted underneath the aluminium breadboard at roughly equally spaced points. The breadboard and all other parts of the larger laser case are preferably also thermally insulated.

The combination of the active temperature control systems of the laser oscillator case and the breadboard ensures a very stable temperature environment (typically 29.0+/−0.03° C.) within the resonator volume despite normal laboratory variations in the ambient temperature. An added layer of temperature stabilization ensures that the output coupler/etalon is preferably held to 29.5+/−0.01° C. in all situations.

In order to achieve ultra-stable lasing, the temperature of the rear-mirror mount is preferably adjusted in a scanning procedure in which the standard deviation of the output energy is monitored as the rear-mirror temperature is slowly increased from 31.0° C. to 39.0° C. over a time period of, for example, 20 minutes. FIG. 7 shows a typical result. The peaks 701 represent cavity lengths in which the oscillator is changing its longitudinal mode. The rear-mirror temperature is preferably set to the middle of the widest stable region 702 which corresponds to the situation, in which the resonator length (in combination with the etalon and laser gain curve) exactly favours the oscillation of a single longitudinal mode. Piezo elements may also be used to vary the cavity length instead of a temperature-controlled rear-mirror.

This procedure preferably ensures that only one longitudinal mode will oscillate for many tens of millions of laser pulses.

The lamp threshold voltage at which lasing first appears typically rises as the lamp wears. The actual voltage applied to the lamp is preferably set at 20 V higher to ensure stable lasing. For a new lamp this corresponds to approximately 575 V and a capacitance of 60 μF. As the lamp wears, lasing will eventually stop due to the voltage falling below threshold. To avoid this, a rapid threshold scan may be performed prior to each laser use/printing job or a predictive model may be used that automatically augments the lamp voltage every 1 million pulses. The use of an automatic system to increase the lamp voltage to compensate for threshold reduction enables ultra-stable lasing to be achieved for up to 200 million pulses. Typical observed energy stabilities are 0.5% RMS over 1000 pulses and +/−3.5% peak-to-peak over 100 million pulses.

The output energy of the short-cavity laser oscillator at 1064 nm is preferably just under 1 mJ TEM₀₀ SLM with a pulse duration of around 45 ns. The pulse duration (if required) can be approximately doubled using circular polarization in the Q-switch instead of linear as the contrast of Cr:YAG is different for these different polarisations. The initial transmission of the Q-switch may also be used to select different pulse lengths although above 82% stability becomes unacceptable.

Smaller pulse durations (corresponding to a lower initial transmission of the Q-switch) correspond to higher energy and even higher energy stability. Using a GSGG Q-switch of T0=19%, for example, enables 8 mJ pulses TEM₀₀ SLM to be obtained (uncoated 13 GHz etalon). Using a Cr:YAG Q-switch of T0=45% enables 4.4 mJ at 13 ns (uncoated 13 GHz etalon) to be obtained. Higher output coupler reflectivities were also used to obtain shorter pulses.

The optimum pumping pulse length is preferably chosen to ensure optimum energy stability. A lamp power supply having an inductance of 40 μH in conjunction with a capacitance of 60 μF is particularly preferred.

### Red and Blue Laser Sources Comprising 1319 nm Laser Oscillator

The red and blue laser sources preferably comprise a 1319 nm short-cavity oscillator which is preferably similar to the 1064 nm oscillator described above with reference to FIGS. 4-6. Referring back to FIG. 4, the rear-mirror 411,412 is replaced with a Fused Silica HR laser-line dielectric mirror having a maximum reflectance at 1319 nm. The Brewster polarizer 413 is designed for operation at 1319 nm. The Q-switch 414 is preferably a Co:MALO crystal that is AR coated on each side for 1319 nm and has an initial transmission of 80%. The ground glass aperture 415 is preferably 1.0 mm diameter (circular). The two quarter-waveplates 416,418 are preferably provided for operation at 1319 nm and AR coated on both sides for 1319 nm and 1064 nm. The active Nd:YAG element 417 preferably comprises a 3 mm diameter cylinder which is preferably 65 mm long. The ends of the cylinder are preferably AR coated for both 1319 nm and 1064 nm. Doping is preferably 1.1% Nd³⁺. The output coupler etalon 419 is preferably a BK7 coated etalon of 6.5 GHz with R=36% at 1319 nm. The etalon is preferably AR coated for 1064 nm.

All temperature control systems and power supplies/cooling arrangements for the 1319 nm oscillator are preferably identical to those used in the 1064 nm oscillator as described above. A heated rear-mirror is preferably used to tune the cavity length as described above and the optimum rear-mirror temperature and the optimum lamp voltage are preferably updated as described before. A mirror mounted on a piezo element may, as before, substitute a heated rear mirror for cavity length control.

Care must be taken to choose the correct lamp pump pulse duration'as too short a pump pulse will selectively favour the 1338 nm line over the 1319 nm line.

Typical SLM TEM₀₀ energies produced by the 1319 nm short-cavity oscillator are 1.2 mJ at 45 ns pulse duration with an RMS stability of 0.67% over 1000 pulses and a peak-to-peak stability over 10 million pulses of +/−3.7%. The typical threshold for operation with a new lamp is 1293 V, 20 μF.

In addition to Co:MALO, V:YAG may also be used as a passive Q-switch with good results. As with the 1064 nm oscillator, changing the output coupler/etalon reflectivity and the initial ( ) switch transmission enables stable TEM₀₀ SLM emissions to be generated having a variety of pulse lengths from 20 to over 100 ns.

The ends of the Nd:YAG crystals for both the 1319 nm and 1064 nm cavities are preferably cut at 3°.

### 532 nm (Green) Laser Source

FIG. 8 shows a 532 nm laser source incorporating a 1064 nm oscillator 801 and a frequency conversion scheme in which radiation at 1064 nm is frequency doubled to 532 nm. The laser is preferably provided on an actively temperature-stabilized aluminium breadboard 802 and is preferably enclosed in a thermally insulated aluminium case as described above. The laser source preferably measures 30 cm×15 cm×18 cm.

The 1064 nm laser oscillator 801 preferably produces a weakly diverging beam at the exit aperture of the oscillator 801. The divergence of this beam is essentially diffraction limited. The beam preferably passes through a half-waveplate 803 which is preferably AR coated for 1064 nm. The beam is then preferably reflected by a HR dielectric mirror 804 to a 10° wedge 805. The wedge 805 is preferably AR coated on the rear surface but is preferably uncoated on the front surface. The wedge 805 preferably reflects a few percent of the beam to a GEM-SI-7511 energy meter 806 (commercially available from Geola Group) which preferably provides the laser control computer with a real-time calibrated energy signal via a dedicated USB port.

The beam preferably continues from the wedge 805 to an HR mirror 807. Lenses 808,809 preferably form a reducing telescope that preferably ensures that the beam has an optimum and almost longitudinally uniform energy density within a type II KTP crystal 810. The crystal 810 is preferably 4 mm×4 mm×10 mm, Type II, θ=90°, φ=24.6°, AR/AR@1064+532 nm and with Z-axis aligned vertically to achieve horizontal 532 nm output. The crystal 810 is preferably mounted in an oven 811 with optical AR coated windows 812,813. The oven temperature is preferably maintained at 35.4° C. The reducing telescope is preferably aligned so as to give the best combination of converted beam uniformity and energy. This may mean accepting greater divergence and a smaller waist.

A final telescope is preferably formed by lenses 814,819 which preferably expands and collimates the output 532 nm beam. The lenses 814,819 preferably produce a 3 mm diameter beam. The output energy is preferably 400 μJ per pulse.

A mirror HR 815 is preferably dichroic and preferably reflects the 532 nm signal whilst transmitting any residual 1064 nm radiation to a beam dump 816. A high speed shutter 817 is preferably provided which is preferably controlled by an interface 818 and which preferably allows the laser beam to be switched as necessary whilst allowing the oscillator to function continuously in order to maintain stability.

### 660 nm (Red) Laser

FIG. 9 shows a 660 nm laser source incorporating a 1319 nm oscillator 901 and a frequency conversion scheme in which radiation at 1319 nm is preferably frequency doubled to 660 nm. The laser source is preferably built on an actively temperature-stabilized aluminium breadboard 902 and is preferably enclosed in a thermally insulated aluminium case as described above. The laser source preferably measures 30 cm×15 cm×18 cm.

A 1319 nm laser oscillator 901 preferably produces a weakly diverging beam at the exit aperture of the oscillator 901. The divergence of this beam is essentially diffraction limited. The beam preferably passes through a half-waveplate 903 which is preferably AR coated for 1319 nm and 1064 nm before being reflected by a HR dielectric mirror 904 to a 10° wedge 905. The wedge 905 is preferably AR coated on the rear surface but uncoated on the front surface. The wedge 905 preferably reflects a few percent of the beam to a GEM-GE-7511 energy meter 906 (commercially available from Geola Group) which preferably provides the laser control computer with a real-time calibrated energy signal via a dedicated USB port.

The beam preferably continues on from the wedge 905 to a HR mirror 907. Lenses 908,909 preferably form a reducing telescope that preferably ensures that the beam has an optimum and almost longitudinally uniform energy density within a LBO crystal 910. The reducing telescope may be aligned so as to give the best combination of converted beam uniformity and energy which may mean accepting greater divergence and a smaller waist.

The LBO crystal 910 preferably comprises a type II 1319(e)+1319(o)→660(e), non-critical temperature phase-matching crystal. The phase-matching temperature for 1319 nm is preferably set at 43.6° C. The crystal 910 is preferably 3 mm×3 mm×30 mm, AR/AR@1319+660 nm and is preferably cut along the Z-axis (θ=0°, φ=0°). Because of no walk-off effects in non-critical phase-matching, it is possible to use a longer crystal to achieve higher conversion efficiency. The crystal 910 is preferably placed with its SHG beam (660 nm) horizontally polarized. The crystal 910 is preferably mounted in an oven 911 with optical AR coated windows 912,913.

A final telescope is preferably formed by lenses 914,919 which preferably expands and collimates the output 660 nm signal. The lenses 914,919 preferably produce a 3 mm diameter beam. The output energy is preferably 400 μJ per pulse.

A mirror HR is preferably dichroic and preferably reflects the 660 nm signal whilst transmitting the residual 1319 nm to a beam dump 916. A high speed shutter 917 controlled by an interface 918 preferably allows the laser beam to be switched as necessary whilst allowing the oscillator to continuously function in order to maintain stability.

### 440 nm (Blue) Laser

FIG. 10 shows a 440 nm laser source incorporating a 1319 nm oscillator 1001 and a frequency conversion scheme in which radiation at 1319 nm is preferably frequency trebled to 440 nm. The laser source is preferably provided on an actively temperature-stabilized aluminium breadboard 1002 and is, preferably enclosed in a thermally insulated aluminium case as described above. The laser source preferably measures 30 cm×15 cm×18 cm.

The 1319 nm laser oscillator 1001 preferably produces a weakly diverging beam at the exit aperture of the oscillator 1001. The divergence of the beam is essentially diffraction limited. The beam preferably passes through a half-waveplate 1003 which is preferably AR coated for 1319 nm and 1064 nm before passing through the first lens of a reducing telescope comprising two lenses 1004,1009. The beam is then reflected by a HR dielectric mirror 1004 to a 10° wedge 1006. The wedge 1006 is preferably AR coated on the rear surface but is preferably uncoated on the front surface. The wedge 1006 preferably reflects a few percent of the beam to a GEM-GE-7511 energy meter (commercially available from Geola Group) 1007 which preferably provides the laser control computer with a real-time calibrated energy signal via a dedicated USB port.

The beam then preferably continues on from the wedge 1006 to a HR mirror 1008. Lenses 1004,1009 preferably form a reducing telescope that preferably ensures that the beam has an optimum and almost longitudinally uniform energy density within two LBO crystals 1010,1014. The first (SHG) crystal 1010 is preferably the same as that used in the red laser i.e. it is a type II 1319(e)+1319(o)→660(e), non-critical phase-matching crystal 3 mm×3 mm×30 mm, AR/AR@1319+660 nm, with a phase-matching temperature of 43.6° C. and cut along the Z-axis (θ=0°, φ=0°). The second (THG) crystal 1014 is preferably a type I 1319(o)+660(o)→440(e) critical phase-matching LBO crystal whose phase-matching angle is preferably θ=90°, φ=21.1°. The THG beam (440 nm) is preferably vertically polarized. Both crystals are preferably mounted in, ovens 1011,1015 with optical AR coated windows 1012,1013,1016,1017.

By adjusting the waveplate 1003 a maximum emission at 440 nm is preferably produced. Residual emissions at 1319 nm and 660 nm are preferably dumped to a beam dump 1020 via a dichroic mirror 1019 which preferably only reflects the 440 nm signal.

According to an embodiment a small off-axis parabolic mirror may be used after the first LBO crystal 1010 to back reflect both the 1319 nm and the 660 nm laser radiation into the second LBO crystal 1014. The advantage of this technique is that the reducing telescope can be optimized for the first LBO crystal 1010 and then the achromatic parabolic mirror can be used separately to optimize both output emissions for the third harmonic conversion.

A telescope is preferably formed by two lenses 1018,1023 which preferably expands and collimates the output 440 nm signal. The lenses are preferably arranged to produce a 3 mm diameter beam. A half-waveplate 1025 preferably rotates the 440 nm polarization to horizontal. The typical output energy is preferably 300 μJ per pulse. A high speed shutter 1021 controlled by interface 1022 preferably allows the laser beam to be switched as necessary whilst allowing the oscillator to function continuously in order to maintain stability.

### Object-Beam Optical System

Conventional commercial holographic printers use transmissive spatial light modulators. As a person skilled in the art will appreciate, it is a non-trivial task to design a commercial pulsed-laser holographic printer that uses a reflective display.

An advantageous aspect of the preferred embodiment is the provision of a telecentric image-relay system for each colour channel in combination with a high-FOV objective lens.

With reference to FIG. 1, according to the preferred embodiment, a real image of a LCOS display 137 is formed at the object plane of a high NA objective 142. The objective 142 in turn preferably forms another real image of the LCOS display 137 at the image plane of the high NA objective 142 which is preferably situated between 80 cm and infinity downstream from the objective 142. The red, green and blue high NA objectives 142 preferably have a diagonal FOV of 101 degrees.

The microlens array 131 preferably confers a finite angular source size onto the object beam. This means that each pixel of the LCOS display 137 is preferably illuminated by rays coming from a variety of angles determined by the microlens array 131 and the one or more conditioning lenses 146. The resolution of the optical system is preferably arranged to be approximately the same as the LCOS resolution in order that the final hologram has a good angular resolution and depth.

An approximate image of the microlens array 131 is preferably formed near the plane of the holographic pixel 116. The lenslet pitch and the one or more conditioning lenses 146 are preferably chosen such that the image fidelity at the image plane of the high NA objective 142 is good (ensuring good angular resolution of the hologram) and also such that the intensity distribution at the holographic pixel is relatively uniform (so that holopixel quantity is good and diffraction efficiency of the hologram acceptable).

If the lenslets are too closely spaced in the microlens array 131 then two problems may result. Firstly, laser radiation from adjacent lenslets may combine and interfere creating a low spatial frequency pattern at the image plane of the high NA objective 142. This will compromise the angular resolution of the final hologram. Secondly, high frequency modulation of the object beam at the holographic pixel plane may occur decreasing diffraction efficiency of the hologram and potentially producing non-uniform holopixels.

If the lenslets are spaced too far apart then image fidelity may suffer at the image plane of the high NA objective 142 due to insufficient averaging out of diffractive defects in the beam-path. In addition, the holographic pixels may become sparsely populated as the lenslets image in completely distinct locations. This can lead to poor quality holographic pixels and a poor diffraction efficiency in the final hologram.

The one or more conditioning lenses 146 may be chosen such that an image of the lens array occurs at an optimum position. This position produces the best quality image of the LCOS display 137 at the image plane of the high NA objective 142 and yet also produces an optimally non-sparse intensity distribution at the object beam holopixel plane.

FIG. 11 shows ray-tracings of the various components in an optical system according to the preferred embodiment from the LCOS display 1104 to the high NA objective 1108 for the red, green and blue channels. FIG. 12 details the optical components used for the red system (listed from left to right with reference to the ray-tracing diagrams). FIG. 13 details the optical components used for the blue system and FIG. 14 details the optical components used for the green system.

FIG. 15 shows an example of the mechanical construction of the (red) optical system excluding the high FOV objective which is mounted separately.

With reference to FIG. 11, the object beam preferably enters the polarizing beamsplitter cube 1103 and is preferably reflected on to the LCOS display 1104 through a meniscus field curvature correction lens 1105. The object beam is then preferably reflected back through the correction lens 1105 and the polarising beam splitter 1103 to a telecentric afocal reversing system which preferably comprises lens systems 1106,1107 which produce a real-image of the LCOS display 1104 at the plane 1102. The high NA objective 1108 preferably produces the required holographic pixel object beam footprint at the Fourier plane 1101.

FIG. 16 shows spot diagrams (for various image plane distances) that have been ray-traced for the entire system from the image plane of the high NA lens system to the LCOS plane for the case of a 1 mm holographic pixel at a wavelength of 526 nm (Nd:YLF laser emission). FIG. 17 shows corresponding spot diagrams in the case of a 0.5 mm holographic pixel. A 12 micron resolution bar indicates that the preferred system meets the LCOS resolution requirements.

### Hologram Copier

The preferred digital holographic printer is preferably able to operate at printing speeds up to 200 Hz using current LCOS displays. However, the overall hologram print speed may still be relatively slow given the small pixels sizes usually required (typically 0.25-1.6 mm). Faster printing speeds are desired for the mass-production market of digital holograms. In order to mass produce holograms, the holograms produced by the preferred holographic printer may advantageously be copied using either a contact or quasi-contact copying system according to an embodiment of the present invention.

A copying system according to a preferred embodiment preferably uses the same pulsed laser sources which are used in the holographic printer according to the preferred embodiment as discussed above. According to other less preferred embodiments higher energy pulsed RGB lasers employing relatively long linear or ring cavity laser oscillators may be used. Such lasers may produce several mJ per colour channel. Alternatively, higher energy amplified short-cavity pulsed lasers may be used. Higher energy multi-diode side-pumped pulsed laser sources may also be used.

According to an embodiment of the present invention a hologram copying system is provided wherein a master RGB reflection hologram is produced using a digital holographic printer. The master reflection hologram has certain characteristics that differentiate it from a hologram that would be generated for direct display and for this reason it is commonly referred to as a master hologram. In particular, a master hologram must replay extremely closely to the original recording wavelengths. In contrast, a hologram printed directly for display would generally be processed such that it possessed significantly down-shifted wavelengths as current red pulsed laser sources required for holographic printing operate in the region of 660 nm and this wavelength is too high for optimum human visual perception. Master holograms should preferably have a good diffraction efficiency and should be free of any defects if they are to produce acceptable copies. Master holograms may be recorded either on film or on glass depending upon the transfer geometry.

The master hologram is preferably brought into close contact with an unexposed holographic film or plate and the resulting sandwich is then preferably exposed by a suitable RGB laser beam at the wavelengths and reference angle(s) at which the master was originally recorded.

Copying systems according to an embodiment of the present invention may be divided into several categories depending upon how the sandwich is made and how the exposure is made. According to a preferred embodiment a flat copying geometry may be used and the sandwich may preferably be created by mounting a film master and an unexposed film together between 12 mm glass plates. Other embodiments are contemplated wherein the master film may be mounted on a roller and the copy film may be arranged to roll over the roller at positive tension.

The exposure can be made in several ways. According to a less preferred embodiment the entire sandwich may be exposed to a single RGB laser pulse. However, for all but the smallest holograms, this technique requires a large amount of energy and hence is generally not preferred for most applications.

According to a preferred embodiment a pencil beam of RGB laser light is preferably formed which is preferably arranged to scan the sandwich left to right and up to down. The pencil beams may be chosen to have an arbitrarily large or small footprint at the sandwich. Depending upon the size of the footprint the copy will either be relatively quick or relatively slow. Generally, however, the quicker the copy then the higher the pulsed energy required.

According to another embodiment the sandwich may be scanned with a carefully prepared line of RGB laser light. Two variants of this method may be used depending on whether the line is horizontally or vertically orientated.

The above copying methods have been experimentally investigated using PFG03CN Silver Halide film (commercially available from the Geola Group) and experimental variations of this film. It has been found that the most successful variant was a line-scanning system wherein the line is orientated vertically.

According to an embodiment of the present invention a vertical line-scanning system may be used which uses a long-cavity RGB laser. This embodiment is illustrated in FIGS. 22-25. The system is preferably arranged to work for a master reflection hologram that has been recorded using a fixed angle collimated reference beam.

FIG. 24 shows a plan view of a preferred hologram copying system. A commercially available long-cavity RGB pulsed laser 2401 is employed as the RGB laser source (Model RGB-ALPHA-1064 available from Geola group). The laser produces separate TEM₀₀ collimated output pulses in the range 35-50 ns at 660 nm (4 mJ), 532 nm (5 mJ) and 440 nm (2.5 mJ). All outputs are SLM and stable over timescales several orders of magnitude larger than typical copying times. The beam diameters are preferably 6 mm FWHM.

The three coloured beams are preferably conditioned separately by computer controlled beam conditioners 2402-2404. These units preferably, comprise a beam attenuator and a beam expander. Each attenuator preferably comprises a half-waveplate mounted in an electromechanically rotating mount paired with a Brewster angle polarizer. Each beam expander preferably comprises an electromechanically controlled adjustable telescope that allows the diameter of the beam to be controlled whilst maintaining collimation.

The three conditioned beams are then preferably combined using dichroic mirrors 2405-2407. The energy and the white-balance of the resulting (variably size-controllable) white beam 2408 is preferably controlled by computer operation of the beam conditioners.

The white beam 2408 is preferably arranged to strike an achromatic mirror 2409 which is preferably mounted on a translatable platform 2410 of a fast electromechanical stage 2411 which is preferably driven by a computer controlled servo-motor 2413 (available from ISEL GmbH). The beam is then preferably steered to illuminate an achromatic cylindrical lens 2412 which is preferably also mounted on the translatable platform 2410. The lens 2412 preferably expands the white beam in one dimension whilst maintaining collimation in the other. The beam, so expanded, then preferably illuminates an off-axis parabolic cylindrical mirror 2414 (see FIG. 25) which is preferably mounted overhead. On reflection from the mirror 2414 the white beam preferably comprises a collimated line beam which is preferably directed to illuminate the film sandwich 2202 preferably at the reference angle at which the original master hologram was recorded. The beam is essentially collimated in both dimensions. The beam preferably traverses a large optical window 2502. When very small line widths are required the diffractive spread in the smaller dimension becomes important. In this case computer control of the telescopes within the beam conditioning systems 2402-2404 allows the line to be focused at the sandwich. This may require an associated computer control of the attenuation units in order to maintain white balance. The mirrors 2405-2407 are preferably computer controlled to ensure that proper overlap of the red, green and blue beams occurs at the sandwich when the beam conditioners are adjusted.

In order to tune the master and copy holograms the sandwich is preferably mounted in a humidity and temperature controlled box 2501.

FIG. 25 shows a side-view of the copying system. Two optical vibration isolation systems are preferably used so that vibrations from the fast movement of the stage 2411 will not cause significant vibrations in the sandwich.

FIG. 22A shows a side detail of a film sandwich in a hologram copying system according to an embodiment of the present invention. The master (PFG03CN) holographic film 2204 is preferably mounted below an unexposed PFG03CN film 2203 in between two 12 mm thick high-quality glass plates 2201,2202. The emulsion layers of both films preferably face each other. The sandwich is preferably illuminated by the white laser pulse 2205 at an angle which preferably exactly matches the recording angle of the master hologram.

FIG. 22B shows a corresponding side view of FIG. 22A and shows the area on the sandwich illuminated by the vertical orientated white laser beam scanning line according to an embodiment of the present invention.

FIG. 23 shows the preferred scanning procedure of the copy process with reference to an overhead view of the sandwich. Initially, the first laser pulse illuminates the strip 2301. The translatable platform 2410 of the stage 2411 is then preferably moved and a second laser pulse preferably illuminates zone 2302. Further movements of the stage (moving preferably at a constant velocity) ensure that subsequent laser pulses illuminate zones 2302-2309 in sequence. The speed of the stage 2411 is preferably chosen to match the repetition rate of the laser (preferably 30 Hz), the width of the slit and the required overlap. Each strip is preferably slightly overlapped such that no striping can be perceived in the final copy holograms which are produced. Before writing the first strip 2301, the stage 2411 is preferably accelerated to a constant velocity such that it is in the right place and travelling at the appropriate velocity when the first strip is written. Since the laser must be operated continuously to ensure stable operation, the internal laser shutters are preferably closed prior to the writing of the first strip and subsequent to writing the last strip. The stage 2411 is preferably aligned exactly orthogonal to the beam 2408.

The orientation of the scanning line beam is referred to hereinafter as being “vertical” as if the final copy hologram is mounted on a wall for display with illumination provided by an overhead light and wherein the pattern of copying which formed the hologram comprises a series of vertical lines across the hologram surface. The advantage of using a vertical orientation is that there is always a certain distance between the master film and the copy film. When the laser line is “horizontal” then the beam first illuminates the copy film 2203 and then reflects off the master film hologram 2204. Since the laser beam is preferably travelling at an angle of 45 degrees to the sandwich and since there is preferably a finite distance between the two films, then the laser beam will preferably illuminate an area of the master slightly downstream of the illuminated area of the copy. This may cause the reflected light from the master hologram to illuminate a slightly offset area of the copy. In the “horizontal” system there may be areas on the copy where, for a given pulse, there is only a reference beam (or only an object beam). If the line width is reduced or if the distance between the films is increased or if the reference angle (with respect to the normal of the sandwich) is increased then this effect may begin to become significant which may result in the copy holograms becoming slightly noisy and dim. A “vertical” scanning geometry, however, is relatively immune to this problem for the case of master holograms having collimated fixed-angle reference beams. Typical line widths for 40×40 cm copy holograms are preferably several millimetres depending upon the overlap ratio.

Relatively large line overlap ratios can be used if vibration levels are relatively low and scanning speeds are relatively high. Generally, the overlapped areas are preferably arranged to possess cross-coherence between the respective pulses if dimming of the copy is to be avoided. Since the laser sources preferably produce stable SLM output then the sandwich is preferably arranged to move less than 1/10^{th} of a fringe between overlapped laser exposures. When such large overlap ratios are to be used then it is possible in theory at least to use high power CW lasersources instead of pulsed RGB laser sources. However, such large overlap ratios are not required per se. Therefore, a copying system with relatively small overlap employing a pulsed laser will work perfectly well in situations wherein CW laser copying systems would certainly not work.

The choice between “vertical” and “horizontal” line scanning depends upon the pulsed laser sources available, the desired field of view of the hologram and whether or not the master hologram has been recorded with a fixed or variable angle reference beam. In all cases a larger slit is advantageous but this has the disadvantage of requiring larger pulse energies and so requires a larger and more expensive laser.

Where the field of view of the master hologram is relatively small then vertical scanning is particularly advantageous. In the case of large fields of view and particularly when the master hologram has been written such that it is designed to be illuminated by a near source (in the case of a variable angle reference beam) then either horizontal or vertical scanning may be used.

It is desirable to ensure that the master hologram replays at exactly the wavelengths of the laser 2401. To ensure this, chemical processing of the master hologram is preferably carefully controlled and the humidity and temperature at which the master hologram is recorded is also preferably precisely controlled. The copy holograms are preferably recorded and processed in such a way that they replay at appropriately downshifted wavelengths. When a RGB laser source is used which emits at 660 nm, 532 nm and 440 nm then a downshift of approximately 20 nm (in the case of the red) is optimal. In this way bright copy holograms are provided. In order to arrange this the humidity and temperature are preferably controlled in the sandwich and this is preferably controlled by a computer controlled humidity and temperature enclosure 2501.

Copying is sensitive to the brightness and noise level of the master hologram. In general, various different processing schemes may be used to augment the brightness of a Silver Halide master hologram. For holograms written in a single step and designed for direct display, various processing schemes that are capable of delivering a very high brightness and low noise image may be too involved and too expensive. However, given that a single master hologram may be used to produce many copies, many of these alternative processing schemes become feasible in the present context.

Two-layer and three-layer panchromatic Silver Halide materials give very high quality results. Multi-layer materials have been produced and are commercially available wherein the various dyes for each respective colour are confined to a given layer.

Although the preferred hologram copier comprises a system wherein a white beam copies line by line an RGB reflection master hologram, other embodiments are contemplated wherein separately generated red, green and blue master holograms are used. Each single colour master hologram may then be copied respectively to separate red, green and blue copy films. The three copy films may then be laminated together to form a final composite RGB copy hologram. The advantage of this technique is that a relatively high brightness can be achieved even for single layer PFG03CN Silver Halide material. Typical holograms copied in this way can be up to three times brighter than the original master holograms. This should be contrasted with typical figures of around 70-90% for single layer Silver Halides and 110-140% for multi-layer Silver Halides. The primary disadvantage of the technique is that the processing and optical geometry must be carefully controlled through the mastering and copying process. In addition three steps are required both at mastering and at copying.

According to another embodiment a single RGB master hologram may be printed and then copies in red, blue and green may be made separately. The copies may then be laminated together. Alternatively, a single RGB master hologram may be printed and then two copies made e.g. one in red and the other in blue and green. These two copies may then be laminated together. Other combinations are also possible.

Photopolymer and other well-known photosensitive materials may be used either for copying or for mastering.

A person skilled in the art will appreciate how the optical scheme of the preferred copier may be modified for variable reference beam geometries e.g. master and copy holograms designed to replay by a close point source.

It will also be evident to a person skilled in the art how transmission holograms may be written and copied.

A hologram copying system according to another embodiment of the present invention referred to hereinafter as “HOLOCOPY” will now be described with reference to FIGS. 18-21. The copier system according to this embodiment is preferably based on the same laser source as used in the preferred copier as described above with reference to FIGS. 22-25. Instead of copying line by line, HOLOCOPY preferably copies spot by spot in a fundamentally two-dimensional fashion. The system can copy up to 1.5 m×1.0 m holograms in under 30 minutes using PFG03CN film.

The optics unit 1801 shown in FIG. 18 preferably comprises a long-cavity RGB SLM TEM₀₀ pulsed laser (with power supply 1803) and an optical system for forming a variable diameter collimated achromatic beam which is then preferably transferred to the copy unit 1802 where the master and copy holograms are preferably located. A control computer 1804 preferably controls the laser and copying process.

HOLOCOPY preferably contact copies a RGB master reflection hologram onto a blank film by 2-dimensionally scanning the master/copy sandwich with a collimated and approximately circular white pulsed laser beam which preferably has a diameter of 4 cm. The laser beam is preferably produced by an RGB pulsed laser operating at 30 Hz. Original master holograms are preferably produced whose emulsion layers preferably have not shrunk during processing as described above.

FIG. 19 shows a front view of the HOLOCOPY copier system, FIG. 20A shows a side view and FIG. 20B shows a plan view.

With reference to FIG. 21, a white laser beam 2101 is preferably arranged to scan a static master/copy sandwich 2106 at a constant angle of incidence by means of mirrors 2102,2103 controlled by a 2-D servo motor-rail-system comprising translating motorized platforms 2104,2105 for each direction respectively. As the beam scans the films at a constant velocity, row by row, the writing beam preferably overlaps the previous column and the previous row. A given point on the copy film is therefore preferably illuminated several times. The master and copy are preferably held very still in order to avoid interference effects on the copy hologram. The optical unit 1801 preferably uses the same arrangement as discussed above in relation to the preferred copier embodiment to control the beam sizes and white-balance:

### HOLOCOPY Mode of Operation

The copying system as shown in FIGS. 18-21 is preferably operated as follows. The system is preferably powered up using a main start button on an electronics rack. The HOLOCOPY system control program is preferably launched on the computer. The control program preferably first initializes all HOLOCOPY controllers and then preferably performs a series of comprehensive function checks on all the separate sub-systems. At this time the laser output shutters are preferably checked as closed and the laser is preferably started. After a period of several minutes GSTAB laser stabilization software is preferably automatically started up. A heated rear mirror is preferably used to adjust actively the internal laser cavity lengths so as to ensure good energy stability. A message preferably appears on the system GUI that the system is now ready for operation.

In order to produce a copy hologram, the system operator preferably inserts the original master film (or glass plate) in the large film holder. An “Open Film Bay Door” button on the system console is preferably pressed. This preferably releases two safety protection latches on the main door and allows the operator to gain access to the large film holder.

A button marked “Raise Top Film Plate” is preferably pressed on the main console and a slider is preferably set to indicate the desired height that the electromechanical system will lift the top film plate.

The operator preferably loads the master film into the large film holder. When the operator is satisfied that they have loaded the film properly then a “Lower Top Film Plate” button is preferably pressed on the system console.

The film bay door is then preferably closed manually and latched using a “Close Film Bay Door” button on the system console.

The operator then preferably goes to a “Set-up Master” window on the system console. The operator preferably has the choice of either recalling previous stored calibration settings or setting new parameters. To load previously stored settings the operator may click on the name of a previous hologram copied. A window preferably displays the names of all previous hologram copies and clicking on any of these preferably loads the appropriate settings. Holograms may deleted from the list or may be loaded using a file-load option if they have been stored on disk and deleted from the console list.

If the operator wishes to load new copy settings or to modify a loaded configuration then the operator may click on a “Modify Copy Settings” icon. This preferably brings up a menu where the following parameters may preferably be changed: red energy, blue energy, green energy, reference angle, horizontal overlap ratio, vertical overlap ratio, start position X, start position Y, end position X, end position Y and wait time to copy.

In order to set the optimum reference angle the system preferably provides a utility that scans a set region of the master hologram using different illumination reference angles. A moving video camera mounted directly overhead the write beam preferably picks up the reflected energy from each illuminated pixel and the computer system preferably calculates the optimum reference angle. Another utility preferably precisely adjusts the humidity in the copy chamber so that the master film emulsion thickness may be tuned.

Various other utilities may be used that allow the operator to determine the start and end X and Y coordinates. An automatic scan may use the internal video system to produce a colour picture of the hologram to be copied on the system console. By clicking on the corners of the picture the start and end X and Y coordinates of the required copy are preferably automatically loaded into the system. If part of a hologram is required to be copied, then the software preferably allows a box to be drawn on any part of the screen. Releasing the mouse will then preferably send the segment coordinates to the system.

Other utilities may be provided including automatic master hologram edge sensing (i.e. a scan which automatically loads the size and position of the master hologram into the system), an automatic colour balance utility and an automatic optimum exposure and overlap utility. These utilities preferably allow an operator to set-up quickly the required copy parameters for a given master and to view on screen what the expected copy is predicted to look like under these chosen settings.

After setting up the copy settings the operator may return to the main menu on the system console. The operator preferably opens the film bay door, extinguishes the room lights and loads an unexposed copy film on top of the master film which is preferably firmly attached to the bottom film plate. When the operator is satisfied that the film has been loaded correctly, the operator preferably lowers the heavy top glass plate of the film holder using the electromechanical system. The operator then preferably closes the film bay and sets the security latches on the system console.

Before starting the copy, the operator preferably checks that the laser stability is sufficient. This is preferably indicated at all times on the system console. The operator can click on the “show laser logs” button for detailed logs of laser energy.

To start the copy the operator preferably presses a “COPY START” button. The system will preferably wait for a set time before starting in order to allow the films to relax in the film holder. As the copy progresses a progress bar is preferably shown on the system console and a video picture of the copy hologram preferably starts to appear showing progress.

If laser stability is compromised during the production of the copy, then a warning may appear from the GSTAB software on the system console and copying may be interrupted. The laser may then auto-cycle and may recalibrate for several minutes before restarting the copy. This process does not preferably affect the quality of the copy.

The system console preferably announces when the copy hologram is ready. The film bay may then be opened. The film holder top plate may be raised and the exposed film may be replaced by another unexposed film. The exposed film may then be processed using hardener, SM6 and a PBU-Amidol bleach. The unexposed film is then preferably printed as described above. Chemical processing of the exposed film is preferably performed within 8 hours from exposure.

Although the copier system described above relates to a system wherein a white beam copies spot by spot an RGB reflection master hologram, other embodiments are contemplated wherein red, green and blue master holograms may be generated separately and each master hologram may be copied onto a red, green and blue copy film. The three copy films may then be laminated together to form a final composite RGB copy hologram. The advantage of this technique is that a higher brightness hologram may be produced even for single layer PFG03CN silver halide material.

According to an embodiment a single RGB master hologram may be provided and red, blue and green copies may be made separately. The copies may then be laminated together.

It will be evident to anyone skilled in the art how the optical scheme of the alternative copier may be modified to cope with a variable reference beam geometry (case of master and copy holograms designed to replay by a close point source).

It will also be evident to persons skilled in the art how transmission holograms may be written and copied.

### Hologram Copying Using Short-Cavity Lamp-Pumped Lasers

2-D spot scanning may be performed according to an embodiment of the present invention using lamp-pumped red, green and blue short-cavity lasers. The short-cavity lasers preferably have a cavity length <200 mm. This allows the same laser sources which are preferably employed in a master holographic printer to be used in the copier. This solution enables an integrated 2-step holographic printer and hologram copier to be provided that is cheaper and simpler to produce. The faster repetition rates available with short-cavity lamp-pumped oscillators offsets the lower energies and hence copy speed is not compromised.

### Hologram Copying Using Short-Cavity Diode-Pumped Lasers

A variant of 2-D spot scanning may also be performed according to another embodiment of the present invention using the higher repetition rates achievable with diode pumped red, green and blue lasers. The short-cavity lasers preferably have a cavity length <200 mm. This allows a square beam footprint smaller or equal in size to the master hologram pixel size to be used for fast copying. A longer pulse length (>90 ns) allows higher diffraction efficiency copies without pixel overlap using conventional silver halides. The distance between the master and copy hologram must be controlled precisely as otherwise the reflected signal from the master will not overlap the copy film.

### Hologram Copying Using Side-Pumped Diode Lasers

Side pumped SLM lasers operating at 1064 nm and 1319 nm may be used to copy holograms either using 2D spot scanning or 1D line scanning. Pumping may be achieved using diode stacks. Tests of such lasers have shown that up to 1 mJ pulses may be generated at repetition rates from 0 to several kHz with pulse lengths of the order of 50 ns. The lasers may also be used for writing 1-step holograms. For silver halide materials, single diodes are sufficient to pump the Nd crystals and hence diode stacks are unnecessary. However, materials such as photopolymers which are much less sensitive to pulsed radiation may be used.

### 2-Step Integrated Printers

By using the same RGB laser to write master holograms and to copy these master holograms, an integrated 2-step printer and copier may be provided which produces both copies and masters. The advantage of such a system is the cost saving of an additional RGB laser source.

### Diode Pumped Short-Cavity Lasers

The 1319 nm and 1064 nm short-cavity lamp-pumped lasers described above may be further modified to be diode-pumped using an end-pumping arrangement. The short-cavity lasers preferably have a cavity length <200 mm. Nd:YAG crystals having a length of 20 mm and a width of 3 mm may be used instead of 65 mm Nd:YAG crystals as used in lamp-pumped cavities (ends cut at 3 degrees). Various Nd doping levels may be used, for example, 1.1%, 0.9% or 0.6%. The 1064 nm crystals are preferably AR coated for 1064 nm and 808 nm and the 1319 nm crystals are preferably AR coated for 1319 nm and 1064 nm on one surface and 1319 nm and 808 nm on the other surface. A modified and shortened pump-chamber design may be used that is similar to the lamp pump-chamber but which is provided with water cooling only. Similar linear resonators may be used (approx 100 mm length) as those described above.

Pumping may be effected with a HLU32F400-808P laser diode driven by an LDD50 power supply available from LIMO GmbH. A 40 W diode output is preferably delivered by fiber to a focusing unit which preferably focuses the light at 808 nm through the rear mirror which is preferably HR coated for 1319 nm or 1064 nm. A V:YAG passive Q-switch may be used in a 1319 nm oscillator and a Cr:YAG Q-switch may be used in a 1064 nm oscillator. A separate output coupler and etalon may be used. In other respects the diode and lamp-pumped resonators are essentially similar. Typical repetition rates for both 1319 nm and 1064 nm oscillators are preferably around 5 kHz and typical pulse energies are around 100 μJ. Pulse durations around 50 ns may be attained. Pulse chopping or pumping modulation is preferably required to produce the slower repetition rates required for holographic printing applications. Suitable pulsed lasing operation from 1 Hz to 5 kHz has been experimentally demonstrated. In addition, by removing the Q-switch, CW lasing at several watts at 1319 nm and 1064 nm may be achieved using CW pumping. This enables CW lasers to be used in copy systems although some modification of the cavity design may be required to effect efficient intra-cavity frequency conversion.

The temperature control provisions described above in the context of lamp-pumped lasers may also be used with diode-pumped lasers. Making the cavity shorter preferably improves stability but temperature is an important determining stability factor except if one goes to the monolithic limit. Accordingly, the pulsed lasers, whether diode or lamp-pumped, are preferably temperature stabilized in the manner described above. Long cavity lasers, for example, may be stabilized interactively with piezo systems but external impulses may disturb such stability. Short-cavity temperature stabilized lasers may, by contrast, be used in a normal commercial environment.

### Amplified Short-Cavity Lasers

The emissions from lamp-pumped and diode-pumped short-cavity laser oscillators may be amplified according to an embodiment of the present invention. One problem with amplification is that the small signal laser gain at 1319 nm is relatively small. The 1064 nm line does not suffer from this problem and stable amplification of this wavelength can be achieved. SBS liquid mirrors may be used in two-pass amplification Schemes as the relatively high gain means that threshold can be achieved usually after a single stage of amplification. In this way multiple SBS two-pass amplifiers can produce energies of up to several Joules with good stability and profile. High energy nanosecond pulsed green laser emissions can be produced.

According to an embodiment the 1319 nm TEM₀₀ SLM output from a long-cavity telescopic laser resonator may be amplified. The laser may comprise a Nd:YAG lamp-pumped crystal and a V:YAG passive Q-switch. The output beam preferably has a repetition rate of 30 Hz. The pulse duration is approximately 55 ns and the output energy per pulse is preferably 17 mJ.

A 6 mm Nd:YAG lamp-pumped amplifier may be provided having a length of 100 mm. A gain of nearly 3× may be observed giving around 45 mJ. Using a larger second amplifier the energy is sufficient to attain a high reflectivity from a SBS liquid mirror allowing a two-pass SBS scheme to be used for this and further amplifiers.

According to an embodiment heavy Freon may be used in the SBS cell as this liquid can produce a high reflectivity. With the gain of 1319 nm around 6 times lower than for 1064 nm, a SBS mirror reflectivity of lower than 80% is not particularly useful.

Red and blue SLM lamp-pumped amplified pulsed lasers with acceptable Gaussian-type profiles may be constructed according to an embodiment on the basis of the amplification of a 1319 nm long-cavity laser oscillator. Energies of the order of 0.5 J may be obtained.

Amplification of the 1319 nm emissions of lamp-pumped or diode-pumped short-cavity pulsed lasers seems problematic since the gain of the 1319 nm line is too low for the low initial energies. Whilst high energies are attainable using 4-pass schemes the beam profiles are poor and stabilities are poor. Pulse shortening also occurs if SBS mirrors are used.

Accordingly, high energy SLM emissions in the blue and red are preferably produced by the amplification of the emissions from longer cavity 1319 nm oscillators. These type of emissions are useful for rapid hologram copying by line-scanning or in the single-pulse copying of entire holograms.

Higher energy pulsed RGB SLM emissions are advantageous for copying as discussed above since as a general rule the higher the energy of the laser source the faster the copying of a hologram. In addition, for large holograms there are certain practical limits on the minimum scan-line width and hence there does exist a practical minimum energy limit for a given size hologram given the copy technique.

In addition to copying applications, materials other than Silver Halide may require fundamentally higher energies. Hence amplification for materials which are more insensitive but which nonetheless produce higher efficiency, cheaper or more desirable holograms. At pressent the most commonly used panchromatic material is Silver Halide.

### Short-Cavity and Diode Lasers Based on Alternative Crystals

Both lamp pumped and diode-pumped SLM TEM₀₀ red, green and blue lasers may be built using different crystals doped with Neodymium. The lasers preferably have a cavity length <200 mm. The crystals YAP and YLF are particularly useful as they allow lasers to be constructed that emit at 656.5 nm (YLF), 539.8 nm (YAP) and 447.2 nm (YAP). These wavelengths, when downshifted by chemical emulsion shrinkage, fall into the emission output ranges of powerful commercially available diode sources. These diodes can therefore be used to illuminate the holograms written with lasers based on these crystals. Similar diodes are not currently available for the 660 nm, 532 nm and 440 nm outputs obtained using Nd:YAG. Consequently, holographic printers which use YAG lasers must currently use halogen lamps for illumination of holograms produced by the printers whereas those based on YAP or YLF can use laser diodes as illumination sources. Laser diodes as an illumination source generally produce a much clearer and brighter image. According to a preferred embodiment Nd:YLF and Nd:YAP crystals may be used as the laser source for a holographic printer. Both these crystals offer similar performance to Nd:YAG and it will be apparent to anyone skilled in the art how the techniques that have been discussed above relating to Nd:YAG lasers can be applied directly to Nd:YLF and Nd:YAP lasers.

Other active media including Nd:BEL may also be used. For example, Nd:BEL may be used to produce a blue output at 450.3 nm. Vanadate (e.g. Nd:YVO₄) can also be used when using diode-pumping. Other embodiments are contemplated wherein other crystals doped with Neodymium 3+ may be used.

### Line-Scan Hologram Copying

Line scanning has some advantages over 2-D row/column scanning. However, for a given size of hologram it may require more energy. This means that 1-D line scanning may require a long-cavity RGB pulsed laser or an amplified short-cavity RGB laser. Film stability considerations may be somewhat relaxed with line scanning as only adjacent rows overlap and this happens very quickly. With 2-D scanning a pixel in the row above is overlapped by the next line and the time difference in this process is usually rather longer. The disadvantage of line scanning is that the optical beam collimation is more complex and requires a larger space. Similar qualities of copy holograms have been obtained using line and 2-D row/column scanning.

### Transmission Holograms

The holographic printer as described above in detail with reference to FIG. 1 may be modified to produce full-colour rainbow transmission holograms by arranging for the reference beam to intersect the object beam from the same side of the photosensitive material as the object beam. These types of holograms can also be copied by a contact copier according to an embodiment of the present invention.

### Further Comments

The high efficiency of modern reflective LCOS SLMs has enabled lower energy red, green and blue pulsed lasers to be used in a digital holographic printer. The requirement for lower laser energy has enabled short-cavity lamp-pumped lasers to be used. A holographic printer according to the preferred embodiment produces a relatively low energy RGB output but is compact and highly stable. Distributed active temperature feedback and control systems enable a very high level of stability to be provided which is necessary to produce flawless digital holograms. The preferred embodiment represents a significant advance in the art especially compared to holograms produced by conventional pulsed-laser digital holographic printers using large and relatively unstable long-cavity lasers because of relatively high energy requirement of transmissive SLMs.

In order to use reflective displays in a holographic printer a complex optical system is required as has been disclosed in the present application.

The temperature-stabilized short-cavity pulsed lasers as described above may according to an embodiment be diode-pumped rather than lamp-pumped. Despite the even lower energy emissions (approximately 100 μJ) it has been shown that such pulsed lasers can be used in digital holographic printers as long as the holographic pixel size is not greater than approximately 1 mm diameter. This allows holographic printers to be produced which are smaller, faster, cheaper and more reliable.

As reflective SLMs become smaller then the optical image-relay system can also be reduced in size. Together with the use of temperature stabilized short-cavity lasers a truly compact digital holographic printer can be provided. According to the preferred embodiment a tabletop holographic printer can be provided.

Short-cavity lasers can also be used to make copy holograms quickly through contact-copying using a spot-scanning 2-D method. The same lasers as used by a master hologram printer can also be used for this task. In this way a compact 2-step hologram printer and copier is provided.

Copy holograms made using pulsed lasers have been shown to be of comparable quality and brightness as the master reflection holograms which were copied. However, this is only true if the master hologram is properly replayed by laser light. In order to do this either the master hologram must be prevented from undergoing emulsion shrinkage at processing time or thereafter, or any such shrinkage must be compensated for by changing the ambient humidity either at master-write time or at the time of the copy. In experiments the humidity was carefully controlled at both the master-write time and at the copy time. By controlling the humidity around the master write time and at the copy time it has been possible to tune a detuned master to the correct wavelengths.

The lighting of the final hologram is an important consideration and the availability of diode sources that can be matched (using a constant emulsion shrinkage) to Nd:YLF and Nd:YAP lasers emissions means that these crystals are currently particularly advantageous until other diode sources become available which can provide a similar match for Nd:YAG.

Lighting by laser diodes is far superior to lighting by halogen lamps. This is particularly true for full-parallax reflection holograms, deep reflection holograms or large, reflection holograms.

Although long-cavity lasers are fundamentally more prone to unstable operation and this makes them less preferred for use in a holographic printer which prints 1-step or master holograms, the fact that copying via line scanning is a substantially faster process than printing a master hologram means that long-cavity lasers can be used effectively in a hologram copying system.

Although the present invention has been described with reference to preferred embodiments, it will be understood by those skilled in the art that various changes in form and detail may be made to the particular embodiments discussed above without departing from the scope of the invention as set forth in the accompanying claims.

1-135. (canceled)

136. A hologram copier comprising a pulsed laser source which outputs, in use, laser radiation at a first wavelength, wherein said hologram copier is arranged to copy a master hologram to form a copy hologram, wherein said master hologram comprises a first group of holopixels which were written substantially at said first wavelength and which have an optimal replay substantially at said first wavelength;
wherein said hologram copier comprises:
means for bringing said master hologram into contact with a photosensitive medium or substrate;
means for illuminating said master hologram with laser radiation from said pulsed laser source at said first wavelength; and
means for controlling at least one of: (i) the humidity of said photosensitive medium or substrate; (ii) and/or the temperature of said photosensitive medium or substrate; and (iii) the chemical processing of said photosensitive medium or substrate, wherein said controlling means is arranged to cause said copy hologram to be formed in or on said photosensitive medium or substrate and wherein said copy hologram comprises a second group of holopixels which have an optimal replay at a second wavelength which is substantially different from said first wavelength.

137. A hologram copier as claimed in claim 136, wherein the difference between said first wavelength and said second wavelength is selected from the group consisting of: (i) <10 nm; (ii) 10-20 nm; (iii) 20-30 nm; (iv) 30-40 nm; (v) 40-50 nm; (vi) 50-60 nm; (vii) 60-70 nm; (viii) 70-80 nm; (ix) 80-90 nm; (x) 90-100 nm; and (xi) >100 nm.

138. A hologram copier as claimed in claim 136, wherein said first group of holopixels were written by a first reference beam substantially at a first angle and having a first beam geometry and wherein said means for illuminating said master hologram with laser radiation from said pulsed laser source at said first wavelength is arranged to illuminate said master hologram with laser radiation from said pulsed laser source at said first wavelength and at substantially said first angle and/or with substantially said first beam geometry.

139. A hologram copier as claimed in claim 136, wherein said pulsed laser source additionally outputs, in use, laser radiation at a third wavelength and wherein said master hologram further comprises a third group of holopixels which were substantially written at said third wavelength and which have an optimal replay substantially at said third wavelength; and
wherein said controlling means is arranged to cause said copy hologram to be formed in or on said photosensitive medium or substrate and wherein said copy hologram comprises a fourth group of holopixels which have an optimal replay at a fourth wavelength which is substantially different from said third wavelength.

140. A hologram copier as claimed in claim 139, wherein the difference between said third wavelength and said fourth wavelength is selected from the group consisting of: (i) <10 nm; (ii) 10-20 nm; (iii) 20-30 nm; (iv) 30-40 nm; (v) 40-50 nm; (vi) 50-60 nm; (vii) 60-70 nm; (viii) 70-80 nm; (ix) 80-90 nm; (x) 90-100 nm; and (xi) >100 nm.

141. A hologram copier as claimed in claim 139, wherein said third group of holopixels were written by a second reference beam substantially at a second angle and having a second beam geometry and wherein said means for illuminating said master hologram with laser radiation from said pulsed laser source at said third wavelength is arranged to illuminate said master hologram with laser radiation from said pulsed laser source at said third wavelength and at substantially said second angle and/or with substantially said second beam geometry.

142. A hologram copier as claimed in claim 139, wherein said pulsed laser source additionally outputs, in use, laser radiation at a fifth wavelength and wherein said master hologram further comprises a fifth group of holopixels which were substantially written at said fifth wavelength and which have an optimal replay substantially at said fifth wavelength; and
wherein said controlling means is arranged to cause said copy hologram to be formed in or on said photosensitive medium or substrate and wherein said copy hologram comprises a sixth group of holopixels which have an optimal replay at a sixth wavelength which is substantially different from said fifth wavelength.

143. A hologram copier as claimed in claim 142, wherein the difference between said fifth wavelength and said sixth wavelength is selected from the group consisting of: (i) <10 nm; (ii) 10-20 nm; (iii) 20-30 nm; (iv) 30-40 nm; (v) 40-50 nm; (vi) 50-60 nm; (vii) 60-70 nm; (viii) 70-80 nm; (ix) 80-90 nm; (x) 90-100 nm; and (xi) >100 nm.

144. A hologram copier as claimed in claim 142, wherein said fifth group of holopixels were written by a third reference beam substantially at a third angle and having a third beam geometry and wherein said means for illuminating said master hologram with laser radiation from said pulsed laser source at said fifth wavelength is arranged to illuminate said master hologram with laser radiation from said pulsed laser source at said fifth wavelength and at substantially said third angle and/or with substantially said third beam geometry.

145. A hologram copier as claimed in claim 136, wherein said pulsed laser source comprises: (i) a first oscillator; (ii) a first and a second oscillator; (iii) a first, a second and a third oscillator.

146. A hologram copier as claimed in claim 145, wherein said first oscillator and/or said second oscillator and/or said third oscillator have a cavity length selected from the group consisting of: (i) <50 mm; (ii) 50-60 mm; (iii) 60-70 mm; (iv) 70-80 mm; (v) 80-90 mm; (vi) 90-100 mm; (vii) 100-110 mm; (viii) 110-120 mm; (ix) 120-130 mm; (x) 130-140 mm; (xi) 140-150 mm; (xii) 150-160 mm; (xiii) 160-170 mm; (xiv) 170-180 mm; (xv) 180-190 mm; and (xvi) 190-200 mm.

147. A hologram copier as claimed in claim 145, wherein said first oscillator and/or said second oscillator and/or said third oscillator have a cavity length selected from the group consisting of: (i) 200-250 mm; (ii) 250-300 mm; (iii) 300-350 mm; (iv) 350-400 mm; (v) 400-450 mm; (vi) 450-500 mm; and (vii) >500 mm.

148. A hologram copier as claimed in claim 136, wherein said hologram copier uses at least one of: (i) a 1D line scanning pattern; and (ii) a 2D spot scanning pattern.

149. A method of copying a hologram comprising:
providing a hologram copier comprising a pulsed laser source which outputs laser radiation at a first wavelength, wherein said hologram copier is arranged to copy a master hologram to form a copy hologram, wherein said master hologram comprises a first group of holopixels which were written substantially at said first wavelength and which have an optimal replay substantially at said first wavelength;
bringing said master hologram into contact with a photosensitive medium or substrate;
illuminating said master hologram with laser radiation from said pulsed laser source at said first wavelength; and
controlling at least one of: (i) the humidity of said photosensitive medium or substrate; (ii) the temperature of said photosensitive medium or substrate; and (iii) the chemical processing of said photosensitive medium or substrate so as to cause said copy hologram to be formed in or on said photosensitive medium or substrate and wherein said copy hologram comprises a second group of holopixels which have an optimal replay at a second wavelength which is substantially different from said first wavelength.
